(19) United States
(12) Patent Application Publication
(10) Pub. No.: US 2023/0265336 A1
(43) Pub. Date: Aug. 24, 2023

(54) COMPOSITION WITH FOAMING PROPERTIES

(71) Applicant: PETROLIAM NASIONAL BERHAD (PETRONAS), Kuala Lumpur (MY)

(72) Inventors: Ching Hsia Ivy CHAI, Kuala Lumpur (MY); Suzalina ZAINAL, Kuala Lumpur (MY); Norzafirah RAZALI, Kuala Lumpur (MY); Ahmad Amirhilmi A RAZAK, Kuala Lumpur (MY); Ridhwan Zhafri Kamarul BAHRIM, Kuala Lumpur (MY)

(21) Appl. No.: 18/012,275

(22) PCT Filed: Jun. 25, 2021
(86) PCT No.: PCT/MY2021/050052

§ 371 Date: Dec. 22, 2022

(30) Foreign Application Priority Data
Jun. 25, 2020 (MY) PI2020003312

(51) Int. Cl. C09K 8/584; C09K 8/594

(52) U.S. Cl. CPC C09K 8/584; C09K 8/594; C09K 2208/06; C09K 2208/18

(57) ABSTRACT

The present invention discloses a composition for enhanced oil recovery comprising olefin sulfonate, sulfo-betaine, betaine and about 0.5 wt % to about 1.5 wt % magnesium chloride.

### TECHNICAL FIELD

The present invention generally relates to a composition with foaming properties. The present invention also relates to the use of said composition in enhanced oil recovery techniques, such as foam-assisted water-alternating-gas processes.

### BACKGROUND ART

Crude oil is a vital source of energy for the world and makes a major contribution to the world economy.

Conventional oil production strategies have followed primary depletion, secondary recovery and tertiary recovery processes. During the primary depletion stage, reservoir drive uses a number of natural mechanisms to displace oil from porous rocks. Recovery factor during the primary recovery stage may average 5-20%. At some point, there will be insufficient underground pressure to force oil to the surface. Secondary recovery methods are then applied wherein the oil is subjected to immiscible displacement with injected fluids such as water or gas. Typical recovery factor after primary and secondary oil recovery operations may be between 30-50%. Much of the remaining oil is trapped in porous media. Tertiary, or enhanced oil recovery (EOR) methods, increase the mobility of oil in order to increase extraction.

There are currently several different methods for EOR, including steam flood and water flood injection and hydraulic fracturing. One method is through a water alternating-gas (WAG) process. WAG injection consists of injection of intermittent slugs of water and gas to improve gas sweep efficiency in the reservoir.

Conventional WAG methods to improve oil recovery are often marred with gas mobility issues due to density and gravity difference between gas and water. Gas has the tendency to move to upper section in a reservoir while water tends to move to the bottom of reservoir, leaving behind regions of unswept oil.

To address this issue, foam can be used to control gas mobility, gas front and early gas breakthrough—ultimately to improve gas sweep efficiency. The use of foams to enhance the WAG process is termed as “Foam-Assisted WAG” or FAWAG, referring to the addition of foaming chemicals into the injection water in the WAG cycle. Foams have an apparent viscosity greater than the displacing medium (e.g. water alone), thus lowering gas mobility in high permeability parts of the formation to recover additional oil.

While foam has been used in EOR processes before, the use of conventional foaming and foam stabilizing mixtures has been problematic. For example, foam compositions in general tend to destabilize when contacted by oil. Accordingly, when used in oil recovery applications, these foam compositions may prematurely destabilize resulting in an undesired loss of sweep efficiency.

Another problem with conventional foaming and foam stabilizing mixtures is their tendency to destabilize under more severe reservoir conditions such as high temperatures (>95° C.). The use of seawater in FAWAG also creates conditions of high salinity (>35,000 ppm) which reduces the life span of foams.

This is disadvantageous in oil recovery applications because foams that dissipate quickly diminish the effectiveness of FAWAG techniques and therefore limiting the oil recovery.

In addition, most developed formulations for FAWAG have not been assessed for their environmental-friendliness for offshore applications as such formulations have mainly concentrated on foam performance.

This poses a problem as there are some countries which do not have any regulations governing the use and discharge of oil recovery chemicals in offshore environments. Overboard discharge of potentially toxic and non-readily biodegradable formulations can be costly to the environment and marine creatures. Further, fluid management of such formulations for disposal into the sea after use is challenging.

Additionally, conventional foam formulations for FAWAG may be costly due to the components and their respective concentrations which make up the formulation.

Hence, there is a need to provide foam compositions useful in FAWAG processes that overcome, or at least ameliorate, one or more of the disadvantages described above.

There is a need to provide a foam composition with relatively long life span.

There is further a need to provide a foam composition that maintains good foam generation and stability under severe reservoir conditions of high temperature and high salinity.

There is further a need to provide a foam composition that is environmentally friendly.

There is also a need to provide a foam composition that is cost-effective.

### SUMMARY OF INVENTION

According to one aspect, the present disclosure refers to a composition for enhanced oil recovery comprising olefin sulfonate, sulfo-betaine, betaine, and about 0.5 wt % to about 1.5 wt % magnesium chloride.

Advantageously, the disclosed composition may be useful to generate stable foams at high temperature and salinity.

Further advantageously, the disclosed composition does not require the use of a polymer in order to generate stable foams at high temperature and salinity. The magnesium chloride in the composition acts as a bridging agent and results in a composition with a viscosity similar or better when compared to a composition that comprises a polymer. The absence of polymer in the disclosed composition is advantageous as it results in a composition which is more cost effective, and environmentally friendly. The disclosed compositions may be non-toxic, biodegradable and have low bioaccumulation. Hence, the disclosed compositions may be disposed directly into the sea with minimal or no negative effects to marine creatures. This again leads to greater cost effectiveness.

Also advantageously, the concentration of magnesium chloride in the range of about 0.5 wt % to 1.5 wt % enhances the stability of the foam composition even in the presence of crude oil which results in improved gas mobility and a resultant increase in total oil recovery during enhanced oil recovery operations.

According to another aspect, the present disclosure refers to a composition disclosed herein, when used to generate stable foams at high temperature and salinity.

According to a further aspect, the present disclosure refers to a composition disclosed herein, when used to generate stable foams at a temperature of about 95° C. to about 110° C.

According to another aspect, the present disclosure refers to a composition disclosed herein, when used to generate stable foams at salinity of more than 35,000 ppm.

According to a further aspect, the present disclosure refers to a composition disclosed herein, when used to generate stable foam lamellae.

According to another aspect, the present disclosure refers to a composition as defined herein, when used in an oil recovery process.

According to a further aspect, the present disclosure refers to a process for preparing a composition disclosed herein, comprising:
(a) preparing a solution comprising about 18.0 wt % to about 20.50 wt % olefin sulfonate, about 10.5 wt % to about 12.5 wt % sulfo-betaine, and about 11.5 wt % to about 12.5 wt % betaine;
(b) preparing a mixture by diluting the solution of step (a) with aqueous medium to a concentration of about 0.3 w/w % to about 0.5 w/w %; and
(c) adding magnesium chloride to the mixture of step (b) to obtain a composition comprising a final concentration of about 0.5 wt % to about 1.5 wt % magnesium chloride.

According to another aspect, the present disclosure refers to a method for recovering oil from a subterranean oil-containing formation comprising:
(a) introducing a composition with foaming properties as defined herein into the subterranean oil-containing formation;
(b) introducing a gas into the subterranean oil-containing formation, wherein the presence of the composition with foaming properties lowers the gas mobility within said formation; and
(c) recovering oil from the formation.

According to a further aspect, the present disclosure refers to a method for recovering oil from a subterranean oil-containing formation comprising:
(a) injecting a composition with foaming properties as defined herein into the subterranean oil-containing formation through one or more injection wells;
(b) introducing a gas into the subterranean oil-containing formation, wherein the presence of the composition with foaming properties lowers the gas mobility within said formation; and
(c) extracting oil from the formation through one or more production wells.

According to another, the present disclosure refers to a composition as defined herein, when used in offshore direct discharge after use.

Advantageously, the composition may be used to generate a foam that exhibits good foam generation and stability under severe reservoir conditions of high temperatures (>95° C.), high salinity (>35,000 ppm) and in the presence of crude oil and a foaming gas.

Advantageously, the composition may be used to generate a foam that displays a high gas Mobility Reduction Factor (MRF) within a reservoir. The MRF may be above 10. The lowered gas mobility advantageously results in improved sweep efficiency. The lowered gas mobility advantageously results in improved sweep efficiency.

Further advantageously, the composition may display regeneration capability and may be used to generate foam even after multiple contacts with a foaming gas.

Advantageously, the composition may display biodegradability and non-toxicity and thus safe to be discharged overboard after use. Hence, the composition with foaming properties may eliminate the use of end-of-pipe solutions and facilities (such as Advance Oxidation Processes), which may translate to substantial cost savings due to less manpower requirement and energy consumption.

Also advantageously, the composition may require a lower application concentration and minimal components in the composition. The components in the composition may be of lower concentrations. These may translate to cost-effectiveness and substantial cost savings.

### Definitions

Unless otherwise defined herein, scientific and technical terms used in this application shall have the meanings that are commonly understood by those of ordinary skill in the art. Generally, nomenclature used in connection with, and techniques of, chemistry described herein, are those well-known and commonly used in the art.

Unless the context requires otherwise or specifically stated to the contrary, integers, steps, or elements of the invention recited herein as singular integers, steps or elements clearly encompass both singular and plural forms of the recited integers, steps or elements.

As used herein, unless otherwise specified, the following terms have the following meanings, and unless otherwise specified, the definitions of each term (i.e. moiety or substituent) apply when that term is used individually or as a component of another term (e.g., the definition of aryl is the same for aryl and for the aryl portion of arylalkyl, alkylaryl, arylalkynyl, and the like).

As used herein, the term “alkyl” includes within its meaning monovalent (“alkyl”) and divalent (“alkylene”) straight chain or branched chain saturated aliphatic groups having from 1 to 20 carbon atoms, eg, 1, 2, 3, 4, 5, 6, 7, 8, 9, 10, 11, 12, 13, 14, 15, 16, 17, 18, 19, or 20 carbon atoms. For example, the term alkyl includes, but is not limited to, methyl, ethyl, 1-propyl, isopropyl, 1-butyl, 2-butyl, isobutyl, tert-butyl, amyl, 1,2-dimethylpropyl, 1,1-dimethylpropyl, pentyl, isopentyl, hexyl, 4-methylpentyl, 1-methylpentyl, 2-methylpentyl, 3-methylpentyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, heptyl, octyl, nonyl, decyl, undecyl, dodecyl, tridecyl, tetradecyl, pentadecyl, hexadecyl, heptadecyl, octadecyl, nonadecyl, eicodecyl and the like. Alkyl groups may be optionally substituted.

As used herein, the term “alkenyl” refers to divalent straight chain or branched chain unsaturated aliphatic groups containing at least one carbon-carbon double bond and having from 2 to 20 carbon atoms, eg, 2, 3, 4, 5, 6, 7, 8, 9, 10, 11, 12, 13, 14, 15, 16, 17, 18, 19, or 20 carbon atoms. For example, the term alkenyl includes, but is not limited to, ethenyl, propenyl, butenyl, 1-butenyl, 2-butenyl, 2-methylpropenyl, 1-pentenyl, 2-pentenyl, 2-methylbut-1-enyl, 3-methylbut-1-enyl, 2-methylbut-2-enyl, 1-hexenyl, 2-hexenyl, 3-hexenyl, 2,2-dimethyl-2-butenyl, 2-methyl-2-hexenyl, 3-methyl-1-pentenyl, 1,5-hexadienyl, heptenyl, octenyl, nonenyl, decenyl, undecenyl, dodecenyl, tridecenyl, tetradecenyl, pentadecenyl, hexadecenyl, heptadecenyl, octadecenyl, nonadecenyl, eicodecenyl and the like. Alkenyl groups may be optionally substituted. As used herein, the term “olefin” refers to alkenyl with one carbon-carbon double bond. An “alpha-olefin” refers to an olefin having a double bond at the primary or alpha position.

As used herein, the term “alkynyl” refers to divalent straight chain or branched chain unsaturated aliphatic groups containing at least one carbon-carbon triple bond and having from 2 to 20 carbon atoms, eg, 2, 3, 4, 5, 6, 7, 8, 9, 10, 11, 12, 13, 14, 15, 16, 17, 18, 19, or 20 carbon atoms. For example, the term alkynyl includes, but is not limited to, ethynyl, propynyl, butynyl, 1-butynyl, 2-butynyl, 2-methylpropynyl, 1-pentynyl, 2-pentynyl, 2-methylbut-1-ynyl, 3-methylbut-1-ynyl, 2-methylbut-2-ynyl, 1-hexynyl, 2-hexynyl, 3-hexynyl, 2,2-dimethyl-2-butynyl, 2-methyl-2-hexynyl, 3-methyl-1-pentynyl, 1,5-hexadiynyl, heptynyl, octynyl, nonynyl, decynyl, undecynyl, dodecynyl, tridecynyl, tetradecynyl, pentadecynyl, hexadecynyl, heptadecynyl, octadecynyl, nonadecynyl, eicodecynyl and the like. Alkynyl groups may be optionally substituted.

The term “carbocycle”, or variants such as “carbocyclic ring” as used herein, includes within its meaning any stable 3, 4, 5, 6, or 7-membered monocyclic or bicyclic or 7, 8, 9, 10, 12, or 13-membered bicyclic or tricyclic, any of which may be saturated, partially unsaturated, or aromatic. The term “carbocycle” includes within its meaning cycloalkyl, cycloalkenyl and aryl groups. Examples of such carbocycles include, but are not limited to, cyclopropyl, cyclobutyl, cyclopentyl, cyclohexyl, cycloheptyl, adamantyl, cyclooctyl, [3.3.0]bicyclooctane, [4.3.0]bicyclononane, [4.4.0]bicyclodecane (decalin), [2.2.2]bicyclooctane, fluorenyl, phenyl, naphthyl, indanyl, adamantyl, or tetrahydronaphthyl (tetralin). Preferred carbocycles, unless otherwise specified, are cyclopropyl, cyclobutyl, cyclopentyl, cyclohexyl, phenyl, naphthyl, and indanyl. Carbocycles may be optionally substituted.

The term “cycloalkyl” as used herein refers to a non-aromatic mono- or multicyclic ring system comprising about 3 to about 10 carbon atoms. The cycloalkyl can be optionally substituted with one or more “ring system substituents” which may be the same or different, and are as defined herein. Non-limiting examples of suitable monocyclic cycloalkyls include cyclopropyl, cyclopentyl, cyclohexyl, cycloheptyl and the like. Non-limiting examples of suitable multicyclic cycloalkyls include 1-decalinyl, norbornyl, adamantyl and the like. Further non-limiting examples of cycloalkyl include the following:

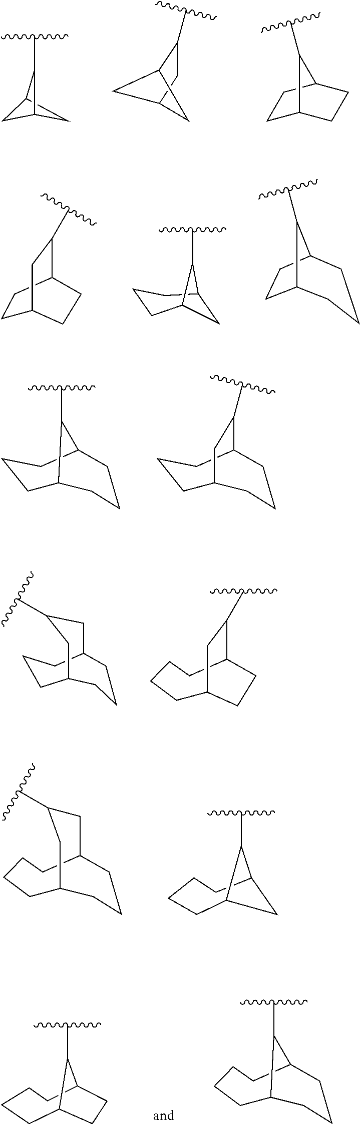

The term “cycloalkenyl” as used herein refers to a non-aromatic mono or multicyclic ring system comprising about 3 to about 10 carbon atoms which contains at least one carbon-carbon double bond. Non-limiting examples of suitable monocyclic cycloalkenyls include cyclopentenyl, cyclohexenyl, cyclohepta-1,3-dienyl, and the like. Non-limiting example of a suitable multicyclic cycloalkenyl is norbornylenyl, as well as unsaturated moieties of the examples shown above for cycloalkyl. Cycloalkenyl groups may be optionally substituted.

The term “aryl”, or variants such as “aromatic group” or “arylene” as used herein refers to monovalent (“aryl”) and divalent (“arylene”) single, polynuclear, conjugated or fused residues of aromatic hydrocarbons having from 6 to 10 carbon atoms. Such groups include, for example, phenyl, biphenyl, naphthyl, phenanthrenyl, and the like. Aryl groups may be optionally substituted.

The term “halogen”, or variants such as “halide” or “halo” as used herein, includes within its meaning fluorine, chlorine, bromine and iodine.

The term “heteroaryl” as used herein refers to an aromatic monocyclic or multicyclic ring system comprising about 5 to about 14 ring atoms, preferably about 5 to about 10 ring atoms, in which one or more of the ring atoms is an element other than carbon, for example nitrogen, oxygen or sulfur, alone or in combination. “Heteroaryl” may also include a heteroaryl as defined above fused to an aryl as defined above. Non-limiting examples of suitable heteroaryls include pyridyl, pyrazinyl, furanyl, thienyl, pyrimidinyl pyridone (including N-substituted pyridones), isoxazolyl, isothiazolyl, oxazolyl, thiazolyl, pyrazolyl, furazanyl, pyrrolyl, pyrazolyl, triazolyl, 1,2,4-thiadiazolyl, pyrazinyl, pyridazinyl quinoxalinyl phthalazinyl, oxindolyl, imidazo[1,2-a]pyrindinyl, imidazo[2,1-b]thiazolyl, benzofurazanyl, indolyl, azaindolyl, benzimidazolyl, benzothienyl, quinolinyl, imidazolyl, thienopyridyl, quinazolinyl, thienopyrimidyl, pyrrolopyridyl, imidazopyridyl, isoquinolinyl, benzoazaindolyl, 1,2,4-triazinyl, benzothiazolyl and the like. The term “heteroaryl” also refers to partially saturated heteroaryl moieties such as, for example, tetrahydroisoquinolyl, tetrahydroquinolyl and the like. Heteroaryl groups may be optionally substituted.

The term “heterocycle” as used herein refers to a group comprising a covalently closed ring herein at least one atom forming the ring is a carbon atom and at least one atom forming the ring is a heteroatom. Heterocyclic rings may be formed by three, four, five, six, seven, eight, nine, or more than nine atoms, any of which may be saturated, partially unsaturated, or aromatic. Any number of those atoms may be heteroatoms (i.e., a heterocyclic ring may comprise one, two, three, four, five, six, seven, eight, nine, or more than nine heteroatoms). Herein, whenever the number of carbon atoms in a heterocycle is indicated (e.g., C1-C6 heterocycle), at least one other atom (the heteroatom) must be present in the ring. Designations such as “C1-C6 heterocycle” refer only to the number of carbon atoms in the ring and do not refer to the total number of atoms in the ring. It is understood that the heterocylic ring will have additional heteroatoms in the ring. In heterocycles comprising two or more heteroatoms, those two or more heteroatoms may be the same or different from one another. Heterocycles may be optionally substituted. Binding to a heterocycle can be at a heteroatom or via a carbon atom. Examples of heterocycles include heterocycloalkyls (where the ring contains fully saturated bonds) and heterocycloalkenyls (where the ring contains one or more unsaturated bonds) such as, but are not limited to the following:

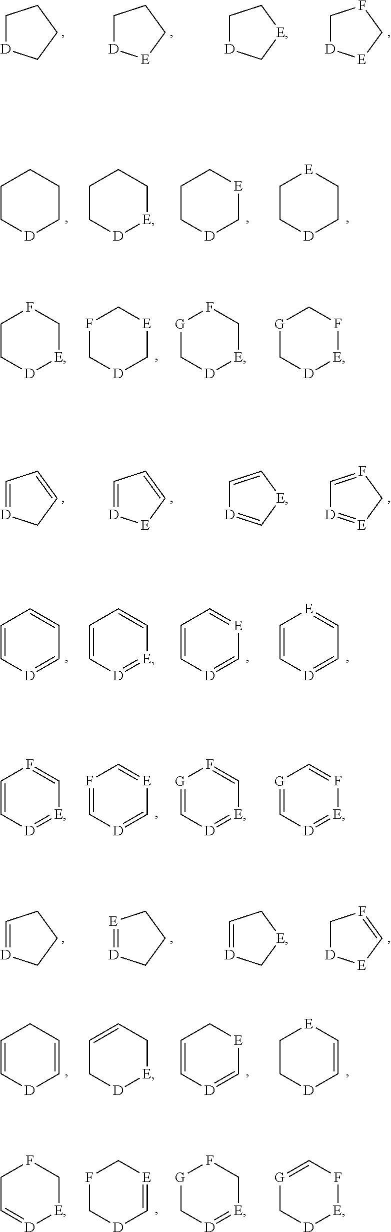

wherein D, E, F, and G independently represent a heteroatom. Each of D, E, F, and G may be the same or different from one another.

The term “optionally substituted” as used herein means the group to which this term refers may be unsubstituted, or may be substituted with one, two, three or more groups other than hydrogen provided that the indicated atom's normal valency is not exceeded, and that the substitution results in a stable compound. Such groups may be, for example, halogen, hydroxy, oxo, cyano, nitro, alkyl, alkoxy, haloalkyl, haloalkoxy, aryl alkoxy, alkylthio, hydroxyalkyl, alkoxyalkyl, cycloalkyl, cycloalkylalkoxy, alkanoyl, alkoxycarbonyl, alkylsulfonyl, alkylsulfonyloxy, alkylsulfonylalkyl, arylsulfonyl, arylsulfonyloxy, arylsulfonylalkyl, alkylsulfonamido, alkylamido, alkylsulfonamidoalkyl, alkylamidoalkyl, arylsulfonamido, arylcarboxamido, arylsulfonamidoalkyl, arylcarboxamidoalkyl, aroyl, aroyl4alkyl, arylalkanoyl, acyl, aryl, arylalkyl, alkylaminoalkyl, a group R^{x}R^{y}N—, R^{x}OCO(CH₂)ₘ, R^{x}CON(R^{y})(CH₂)ₘ, R^{x}R^{y}NCO(CH₂)ₘ, R^{x}R^{y}NSO₂(CH₂)ₘ or RSO₂NR^{y}(CH₂)ₘ (where each of R^{x} and R^{Y} is independently selected from hydrogen or alkyl, or where appropriate R^{x}R^{y} forms part of carbocylic or heterocyclic ring and m is 0, 1, 2, 3 or 4), a group R^{x}R^{y}N(CH)ₚ— or R^{x}R^{y}N(CH₂)ₚO— (wherein p is 1, 2, 3 or 4), wherein when the substituent is R^{x}R^{y}N(CH₂)ₚ— or R^{x}R^{y}N(CH₂)ₚO, R^{x} with at least one CH₂ of the (CH₂), portion of the group may also form a carbocyclyl or heterocyclyl group and R^{y} may be hydrogen, alkyl.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF EMBODIMENTS

This present invention seeks to provide a foam composition that has high enhanced oil recovery (EOR) performance and is environmentally-friendly, to reduce the burden of fluid management. The invention also seeks to confidently discharge the foam composition overboard without extra intervention.

The present invention relates to a composition which can alleviate problems related to conventional water alternating-gas (WAG), and yet having the additional benefit of being environmentally friendly and cost-effective.

The present invention also relates to foam-surfactant formulations that may generate stable foams in subterranean environments of high temperatures (for example, above 95° C.), and tolerant to crude oil (which is known to be deleterious to foams).

In one aspect, the present disclosure refers to a composition for enhanced oil recovery comprising olefin sulfonate, sulfo-betaine, betaine, and about 0.5 wt % to about 1.5 wt % magnesium chloride.

The olefin sulfonate of the disclosed composition may provide the composition with high temperature tolerance (for example, above 90° C.) and may reduce adsorption to reservoir walls. The olefin sulfonate may also provide the composition with foam generation capabilities, and may provide negative charges to the composition, thus providing electrical repulsion between two opposite faces of foam lamella to prevent foam thinning and making it less sensitive to adsorption on clayey reservoirs.

The olefin sulfonate of the disclosed composition may be sodium alpha-olefin sulfonate. The alpha-olefin group may be selected from C₃ to C₁₈ alpha olefin, such as 1-propenyl, 1-butenyl, 1-pentenyl, 1-hexenyl, 1-heptenyl, 1-octenyl, 1-nonenyl or 1-decenyl, 1-undecenyl, 1-dodecenyl, 1-tridecenyl, 1-tetradecenyl, 1-pentadecenyl, 1-hexadecenyl, 1-heptadecenyl, 1-octadecenyl, 1-nonadecenyl or 1-eicosenyl. The alpha-olefin group may be a C₁₄ to C₁₆ alpha olefin. The olefin sulfonate may be of the formula CHₙH₂ₙ₋₁SO₃M, wherein n is an integer of 14, 15, or 16, and M is a counterion, such as Na⁺.

The olefin sulfonate may be a compound of Formula (I):

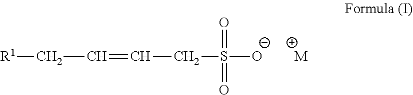

wherein R¹ is an optionally substituted alkyl, alkenyl or alkynyl and M⁺ is sodium. R¹ may be optionally substituted C₁₀ to C₁₂ alkyl, alkenyl or alkynyl.

In a compound of Formula (I), R¹ may be selected from optionally substituted alkyl, alkenyl or alkynyl. R¹ may be selected from an optionally substituted alkyl group selected from optionally substituted methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, or eicodecyl. R¹ may be substituted or unsubstituted. The optional substituents on R¹ may be C₁₋₆ alkyl, C₂₋₄ alkenyl, C₂₋₄ alkynyl, C₁₋₆ alkoxy, amino, sulfinyl, sulfonyl, carbonyl, aryl, heteroaryl, carbocyclyl, or heterocyclyl, hydroxyl, carboxylic acid, cyano or halogen. R¹ may be C₁₀ to C₁₂ alkyl. R¹ may be C₁₀ or C₁₂ alkyl.

The olefin sulfonate may be selected from the group consisting of the following compounds:

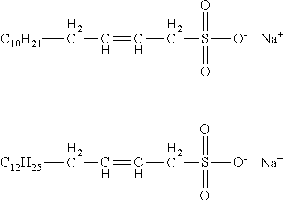

The sulfo-betaine of the disclosed composition may be a foam booster. The betaine group may provide a synergistic effect to the olefin sulfonate surfactant to increase its foaminess.

The sulfo-betaine of the disclosed composition may be any neutral compound with a positively charged cationic group and a negatively charged functional group which is a sulfo-group. The sulfo-betaine may be of the formula (CHₙH₂ₙ₊₁)—CONH(CH₂)₃N⁺(CH₃)₂CH₂CH(OH)CH₂SO₃⁻, wherein n is an integer of 11, 12 or 13. The sulfo-betaine may be a compound of Formula (II):

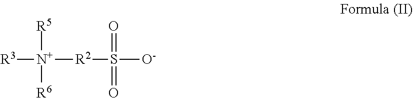

wherein R² is optionally substituted alkylene, alkenylene or alkynylene;
R³ is optionally substituted alkyl, alkenyl or alkynyl; and
R³ and R⁶ each are independently optionally substituted alkyl, alkenyl, alkynyl, aryl, heteroaryl, carbocyclyl, heterocyclyl.

In a compound of Formula (II), R² may be selected from optionally substituted alkylene, alkenylene or alkynylene. R² may be selected from an optionally substituted alkylene group selected from optionally substituted methylene, ethylene, propylene, butylene, pentylene, hexylene, heptylene, octylene, nonylene, decylene, undecylene, dodecylene, tridecylene, tetradecylene, pentadecylene, hexadecylene, heptadecylene, octadecylene, nonadecylene, or eicodecylene. R² may be substituted or unsubstituted. The optional substituents on R² may be C₁₋₆ alkyl, C₂₋₄ alkenyl, C₂₋₄ alkynyl, C₁₋₆ alkoxy, amino, sulfinyl, sulfonyl, carbonyl, aryl, heteroaryl, carbocyclyl, or heterocyclyl, hydroxyl, carboxylic acid, cyano or halogen. R² may be an optionally substituted alkylene. R² may be an alkylene group substituted with a hydroxygroup. R² may be a methylene, ethylene, propylene or butylene substituted with hydroxy. R² may be —(CH₂)₂—CH(OH)—, —CH₂—CH(OH)—CH₂— or —CH(OH)—(CH₂)₂—.

In a compound of Formula (II), R³ may be selected from optionally substituted alkyl, alkenyl or alkynyl. R³ may be selected from an optionally substituted alkyl group selected from optionally substituted methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, or eicodecyl. R³ may be substituted or unsubstituted. The optional substituents on R³ may be C₁₋₆ alkyl, C₂₋₄ alkenyl, C₂₋₄ alkynyl, C₁₋₆ alkoxy, amino, sulfinyl, sulfonyl, carbonyl, aryl, heteroaryl, carbocyclyl, or heterocyclyl, hydroxyl, carboxylic acid, cyano, halogen or alkylamido. R³ may be an optionally substituted alkyl. R may be an alkyl substituted with alkylamido. R³ may be [C₁₁₋₁₃ alkyl]-C(O)NH—(CH₂)₃—. R³ may be [C_{11 or 13} alkyl]-C(O)NH—(CH₂)₃—.

In a compound of Formula (II), R³ and R⁶ may each be selected from optionally substituted alkyl, alkenyl, alkynyl, aryl, heteroaryl, carbocyclyl, heterocyclyl. R⁵ and R⁶ may each be alkyl selected from methyl, ethyl, propyl, butyl, pentyl or hexyl. R⁵ and R⁶ may each be alkenyl selected from ethenyl, propenyl, butenyl, pentenyl or hexenyl. R³ and R⁶ may each be alkynyl selected from ethynyl, propynyl, 1-butynyl, 2-butynyl, 1-pentynyl, 2-pentynyl, 1-hexynyl, 2-hexynyl, 3-hexynyl or 3-methyl-1-pentynyl. R⁵ and R⁶ may each be aryl selected from phenyl or naphthyl. R³ and R⁶ may each be heteroaryl selected from pyrroline, pyrrolidine, imidazoline, imidazolidine, pyrazoline, pyrazolidine, pyrane, piperidine, morpholine, thiomorpholine, piperazine or hydrofuran. R³ and R⁶ may each be substituted or unsubstituted. The optional substituents on R⁵ or R⁶ may be C₁₋₆ alkyl, C₂₋₄ alkenyl, C₂₋₄ alkynyl, C₁₋₆ alkoxy, amino, sulfinyl, sulfonyl, carbonyl, aryl, heteroaryl, carbocyclyl, or heterocyclyl, hydroxyl, carboxylic acid, cyano or halogen. R⁵ and R⁶ may each independently be optionally substituted alkyl, R⁵ and R⁶ may each independently be methyl, ethyl or propyl.

The sulfo-betaine of the disclosed composition may be an alkyl amidopropyl hydroxy sulfo-betaine of formula (IIA):

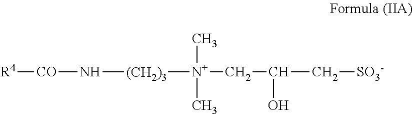

wherein R⁴ is an optionally substituted alkyl, alkenyl or alkynyl.

In a compound of Formula (IIA), R⁴ may be selected from optionally substituted alkyl, alkenyl or alkynyl. R⁴ may be selected from an optionally substituted alkyl group selected from optionally substituted methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, or eicodecyl. R⁴ may be substituted or unsubstituted. The optional substituents on R may be C₁₋₆ alkyl, C₂₋₆ alkenyl, C₂₋₆ alkynyl, C₁₋₆ alkoxy, amino, sulfinyl, sulfonyl, carbonyl, aryl, heteroaryl, carbocyclyl, or heterocyclyl, hydroxyl, carboxylic acid, cyano or halogen. R⁴ may be an optionally substituted alkyl group. R may be optionally substituted C₁₁ to C₁₃ alkyl. R⁴ may be optionally substituted C₁₁ or C₁₃ alkyl.

The sulfo-betaine of the disclosed composition may be a compound selected from the group consisting of the following compounds:

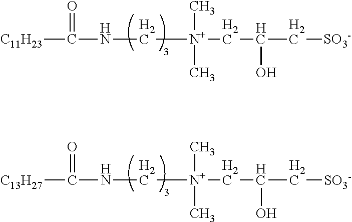

The betaine of the disclosed composition may a foam booster. The betaine group may provide a synergistic effect to the olefin sulfonate surfactant to increase its foaminess.

The betaine of the disclosed composition may be of Formula (III):

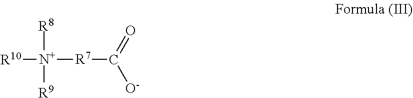

wherein R⁷ is optionally substituted alkylene, alkenylene or alkynylene;
R¹⁰ is optionally substituted alkyl, alkenyl or alkynyl; and
R⁸ and R⁹ each are independently optionally substituted alkyl, alkenyl, alkynyl, aryl, heteroaryl, carbocyclyl, heterocyclyl.

In a compound of Formula (III), R⁷ may be selected from optionally substituted alkylene, alkenylene or alkynylene. R⁷ may be selected from an optionally substituted alkylene group selected from optionally substituted methylene, ethylene, propylene, butylene, pentylene, hexylene, heptylene, octylene, nonylene, decylene, undecylene, dodecylene, tridecylene, tetradecylene, pentadecylene, hexadecylene, heptadecylene, octadecylene, nonadecylene, or eicodecylene. R⁷ may be substituted or unsubstituted. The optional substituents on R⁷ may be C₁₋₆ alkyl, C₂₋₆ alkenyl, C₂₋₆ alkynyl, C₁₋₆ alkoxy, amino, sulfinyl, sulfonyl, carbonyl, an, heteroaryl, carbocyclyl, or heterocyclyl, hydroxyl, carboxylic acid, cyano or halogen. R⁷ may be an optionally substituted alkylene. R⁷ may be optionally substituted methylene, ethylene, propylene or butylene.

In a compound of Formula (III), R¹⁰ may be selected from optionally substituted alkyl, alkenyl or alkynyl. R¹⁰ may be selected from an optionally substituted alkyl group selected from optionally substituted methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, or eicodecyl. R¹⁰ may be substituted or unsubstituted. The optional substituents on R¹⁰ may be C₁₋₆ alkyl, C₂₋₆ alkenyl, C₂₋₆ alkynyl, C₁₋₆ alkoxy, amino, sulfinyl, sulfonyl, carbonyl, aryl, heteroaryl, carbocyclyl, or heterocyclyl, hydroxyl, carboxylic acid, cyano, halogen or alkylamido. R¹⁰ may be an optionally substituted alkyl. R¹⁰ may be an alkyl substituted with alkylamido. R¹⁰ may be [C₁₁₋₁₃ alkyl]-C(O)NH—(CH₂)₃, R¹⁰ may be [C_{11 or 13} alkyl]-C(O)NH—(CH₂)—.

In a compound of Formula (III), R⁸ and R⁹ may each be selected from optionally substituted alkyl, alkenyl, alkynyl, aryl, heteroaryl, carbocyclyl, heterocyclyl. R⁸ and R⁹ may each be alkyl selected from methyl, ethyl, propyl, butyl, pentyl or hexyl. R⁸ and R⁹ may each be alkenyl selected from ethenyl, propenyl, butenyl, pentenyl or hexenyl. R⁸ and R⁹ may each be alkynyl selected from ethynyl, propynyl, 1-butynyl, 2-butynyl, 1-pentynyl, 2-pentynyl, 1-hexynyl, 2-hexynyl, 3-hexynyl or 3-methyl-1-pentynyl. R⁸ and R⁹ may each be aryl selected from phenyl or naphthyl. R⁸ and R⁹ may each be heteroaryl selected from pyrroline, pyrrolidine, imidazoline, imidazolidine, pyrazoline, pyrazolidine, pyrane, piperidine, morpholine, thiomorpholine, piperazine or hydrofuran. R⁸ and R⁹ may each be substituted or unsubstituted. The optional substituents on R⁸ or R⁹ may be C₁₋₆ alkyl, C₂₋₆ alkenyl, C₂₋₆ alkynyl, C₁₋₆ alkoxy, amino, sulfinyl, sulfonyl, carbonyl, aryl, heteroaryl, carbocyclyl, or heterocyclyl, hydroxyl, carboxylic acid, cyano or halogen. R⁸ and R⁹ may each independently be optionally substituted alkyl. R⁸ and R⁹ may each independently be methyl, ethyl or propyl.

The betaine of the disclosed composition may be of formula (IIIA):

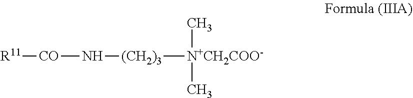

wherein R¹¹ is an optionally substituted alkyl, alkenyl or alkynyl.

In a compound of Formula (IIIA), R¹¹ may be selected from optionally substituted alkyl, alkenyl or alkynyl. R¹¹ may be selected from an optionally substituted alkyl group selected from optionally substituted methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, or eicodecyl. R¹¹ may be substituted or unsubstituted. The optional substituents on R¹¹ may be C₁₋₆ alkyl, C₂₋₆ alkenyl, C₂₋₆ alkynyl, C₁₋₆ alkoxy, amino, sulfinyl, sulfonyl, carbonyl, aryl, heteroaryl, carbocyclyl, or heterocyclyl, hydroxyl, carboxylic acid, cyano or halogen. R¹¹ may be an optionally substituted alkyl group. R¹¹ may be optionally substituted C₁₁ to C₁₃ alkyl. R¹¹ may be optionally substituted C₁₁ or C₁₃ alkyl.

The betaine of the disclosed composition may be selected from the group consisting of the following compounds:

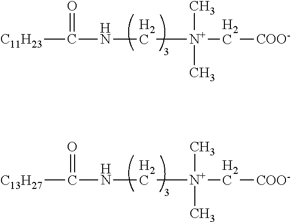

The magnesium chloride of the disclosed composition may be a foam stabilizer. The magnesium chloride may display synergistic activity and compatibility with the components of the composition with foaming properties. The magnesium chloride may form a crystal lattice complex providing a bridging effect and high viscosity, thus keeping foams thick and reducing the drainage rate of liquid from foam lamellae. This increase in viscosity may provide the lamellae with “self-healing” or re-generation capabilities—a key feature that eliminates the need for constant re-injection of surfactant(s) which may allow for a minimal surfactant concentration during application. Magnesium chloride is advantageously certified as GRAS (Generally recognized as safe) by FDA (Food and Drug Administration) whereby chemicals under this category are considered to be non-toxic to human and environment and safe for use in food ingredient and pharmaceuticals. The magnesium chloride is advantageously a PLONOR (=Pose Little or No Risk)-listed compound by the OSPAR Commission whereby chemicals under this category are considered to be readily biodegradable and non-toxic.

The total concentration of magnesium chloride in the composition may range from about 0.5 wt % to about 1.5 wt %. The total concentration of magnesium chloride in the composition may range from about 0.5 wt % to about 1.4 wt %, about 0.5 wt % to about 1.3 wt %, about 0.5 wt % to about 1.2 wt %, about 0.5 wt % to about 1.1 wt %, about 0.5 wt % to about 1.0 wt %, about 0.5 wt % to about 0.9 wt %, about 0.5 wt % to about 0.8 wt %, about 0.5 wt % to about 0.7 wt %, about 0.5 wt % to about 0.6 wt %, about 0.5 wt % to about 0.59 wt %, about 0.5 wt % to about 0.58 wt %, about 0.5 wt % to about 0.57 wt %, about 0.5 wt % to about 0.56 wt %, about 0.5 wt % to about 0.55 wt %, about 0.5 wt % to about 0.54 wt %, about 0.5 wt % to about 0.53 wt %, about 0.5 wt % to about 0.52 wt %, about 0.5 wt % to about 0.51 wt %, about 0.51 wt % to about 1.5 wt %, about 0.52 wt % to about 1.5 wt %, about 0.53 wt % to about 1.5 wt %, about 0.54 wt % to about 1.5 wt %, about 0.55 wt % to about 1.5 wt %, about 0.56 wt % to about 1.5 wt %, about 0.57 wt % to about 1.5 wt %, about 0.58 wt % to about 1.5 wt %, about 0.59 wt % to about 1.5 wt %, about 0.6 wt % to about 1.5 wt %, about 0.7 wt % to about 1.5 wt %, about 0.8 wt % to about 1.5 wt %, about 0.9 wt % to about 1.5 wt %, about 1.0 wt % to about 1.5 wt %, about 1.1 wt % to about 1.5 wt %, about 1.2 wt % to about 1.5 wt %, about 1.3 wt % to about 1.5 wt %, about 1.4 wt % to about 1.5 wt %, or about 0.5 wt %, about 0.51 wt %, about 0.52 wt %, about 0.53 wt %, about 0.54 wt %, about 0.55 wt %, about 0.56 wt %, about 0.57 wt %, about 0.58 wt %, about 0.59 wt %, about 0.6 wt %, about 0.7 wt %, about 0.8 wt %, about 0.9 wt %, about 1.0 wt %, about 1.1 wt %, about 1.2 wt %, about 1.3 wt %, about 1.4 wt %, or about 1.5 wt %. It is to be appreciated that the above ranges should be interpreted as including and supporting any sub-ranges or discrete values (which may or may not be a whole number) that are within the stated range(s).

The specific concentration of about 0.5 wt % to about 1.5 wt % is chosen because foaming compositions containing below 0.5 wt % of magnesium chloride result in a short foam half life, and above 1.5 wt %, turbidity is observed in the foaming composition.

It is hypothesized that the short foam half life observed for foaming compositions containing less than 0.5 wt % of magnesium chloride results as the bridging effect between the crystal lattice complex and surfactants does not occur. In other words, when magnesium chloride is present at a concentration of less than 0.5 wt %, it is unable to bridge between adjacent foam lamellae generated by the surfactant (foam formulation) and does not strengthen the foams any further.

It is also hypothesized that at a concentration higher than 1.5 wt %, too much ions are present at the lamellae, leading to the ‘congestion’ (=turbidity) at the plateau border, competing with surfactants in building lamella, leading to the collapse of the foam.

The disclosed composition for enhanced oil recovery may comprise:
a solution comprising an aqueous medium and a mixture comprising about 18.0 wt % to about 20.50 wt % olefin sulfonate, about 10.5 wt % to about 12.5 wt % sulfo-betaine, and about 11.5 wt % to about 12.5 wt % betaine, wherein said mixture is diluted in the aqueous medium to about 0.3 w/w % to about 0.5 w/w %; and
about 0.5 wt % to about 1.5 wt % magnesium chloride.

The solution may be diluted in aqueous medium to about 0.3 w/w % to about 0.5 w/w %, or about 0.35 w/w % to about 0.5 w/w %, about 0.4 w/w % to about 0.5 w/w %, about 0.45 w/w % to about 0.5 w/w %, about 0.3 w/w % to about 0.45 w/w %, about 0.3 w/w % to about 0.4 w/w %, about 0.3 w/w % to about 0.35 w/w %, or about 0.3 w/w %, about 0.35 w/w %, about 0.4 w/w %, about 0.45 w/w %, or about 0.5 w/w %. It is to be appreciated that the above ranges should be interpreted as including and supporting any sub-ranges or discrete values (which may or may not be a whole number) that are within the stated range(s).

The aqueous medium may be water, surface water, ground water, brackish water, brine or seawater.

The active concentration of olefin sulfonate in the solution may range from about 18 wt % to about 20.5 wt %, about 18.25 wt % to about 20.5 wt %, about 18.5 wt % to about 20.5 wt %, about 18.75 wt % to about 20.5 wt %, about 19 wt % to about 20.5 wt %, about 19.25 wt % to about 20.5 wt %, about 19.5 wt % to about 20.5 wt %, about 19.75 wt % to about 20.5 wt %, about 20 wt % to about 20.5 wt %, about 20.25 wt % to about 20.5 wt %, about 18 wt % to about 20.25 wt %, about 18 wt % to about 20 wt %, about 18 wt % to about 19.75 wt %, about 18 wt % to about 19.5 wt %, about 18 wt % to about 19.25 wt %, about 18 wt % to about 19 wt %, about 18 wt % to about 18.75 wt %, about 18 wt % to about 18.5 wt %, about 18 wt % to about 18.25 wt %, or about 18 wt %, about 18.25 wt %, about 18.5 wt %, about 18.71 wt %, about 18.75 wt %, about 19 wt %, about 19.25 wt %, about 19.5 wt %, about 19.75 wt %, about 20 wt %, about 20.25 wt %, or about 20.5 wt %. It is to be appreciated that the above ranges should be interpreted as including and supporting any sub-ranges or discrete values (which may or may not be a whole number) that are within the stated range(s).

The quantity of active sulfo-betaine in the mixture may range from about 10.5 to about 12.5 wt %, about 10.6 to about 12.5 wt %, about 10.7 to about 12.5 wt %, about 10.8 to about 12.5 wt %, about 10.9 to about 12.5 wt %, about 11.0 to about 12.5 wt %, about 11.1 to about 12.5 wt %, about 11.2 to about 12.5 wt %, about 11.3 to about 12.5 wt %, about 11.4 to about 12.5 wt %, about 11.5 to about 12.5 wt %, about 11.6 to about 12.5 wt %, about 11.7 to about 12.5 wt %, about 11.8 to about 12.5 wt %, about 11.9 to about 12.5 wt %, about 12.0 to about 12.5 wt %, about 12.05 to about 12.5 wt %, about 12.1 to about 12.5 wt %, about 12.2 to about 12.5 wt %, about 12.3 to about 12.5 wt %, about 12.4 to about 12.5 wt %, about 10.5 to about 12.4 wt %, about 10.5 to about 12.4 wt %, about 10.5 to about 12.4 wt %, about 10.5 to about 12.4 wt %, about 10.5 to about 12.4 wt %, about 10.5 to about 12.3 wt %, about 10.5 to about 12.2 wt %, about 10.5 to about 12.1 wt %, about 10.5 to about 12.0 wt %, about 10.5 to about 11.9 wt %, about 10.5 to about 11.8 wt %, about 10.5 to about 11.7 wt %, about 10.5 to about 11.6 wt %, about 10.5 to about 11.5 wt %, about 10.5 to about 11.4 wt %, about 10.5 to about 11.3 wt %, about 10.5 to about 11.2 wt %, about 10.5 to about 11.1 wt %, about 10.5 to about 11.0 wt %, about 10.5 to about 10.9 wt %, about 10.5 to about 10.8 wt %, about 10.5 to about 10.7 wt %, about 10.5 to about 10.6 wt %, or about 10.5 wt %, about 10.6 wt %, about 11.0 wt %, about 10.7 wt %, about 10.8 wt %, about 10.9 wt %, about 11.0 wt %, about 11.1 wt %, about 11.2 wt % about 11.3 wt % about 11.4 wt %, about 11.5 wt %, about 11.6 wt %, about 11.7 wt %, about 11.8 wt %, about 11.9 wt %, about 12.0 wt %, about 12.1 wt %, about 12.2 wt %, about 12.3 wt %, about 12.4 wt %, or about 12.5 wt %. It is to be appreciated that the above ranges should be interpreted as including and supporting any sub-ranges or discrete values (which may or may not be a whole number) that are within the stated range(s).

The quantity of active betaine in the mixture may range from about 11.5 to about 12.5 wt %, about 11.6 to about 12.5 wt %, about 11.7 to about 12.5 wt %, about 11.8 to about 12.5 wt %, about 11.9 to about 12.5 wt %, about 12.0 to about 12.5 wt %, about 12.05 to about 12.5 wt %, about 12.1 to about 12.5 wt %, about 12.2 to about 12.5 wt %, about 12.3 to about 12.5 wt %, about 12.4 to about 12.5 wt %, or about 11.5 wt %, about 11.6 wt %, about 11.7 wt %, about 11.75 wt %, about 11.8 wt %, about 11.9 wt %, about 12.0 wt %, about 12.05 wt %, about 12.09 wt %, about 12.1 wt %, about 12.2 wt %, about 12.3 wt %, about 12.4 wt %, or about 12.5 wt %. It is to be appreciated that the above ranges should be interpreted as including and supporting any sub-ranges or discrete values (which may or may not be a whole number) that are within the stated range(s).

The solution may be a foam solution comprising a three-component foam-surfactant formulation whereby each component consists of different functional groups to tackle challenging conditions of the reservoir. The olefin sulfonate may provide the composition with high temperature tolerance (for example, above 90° C.) and may reduce adsorption to reservoir walls. The olefin sulfonate may also provide the composition with foam generation capabilities, and may provide negative charges to the composition, thus providing electrical repulsion between two opposite faces of foam lamella to prevent foam thinning and making it less sensitive to adsorption on clayey reservoirs. The betaine and sulfo-betaine may be foam boosters. The betaine and sulfo-betaine groups may provide a synergistic effect to the olefin sulfonate surfactant to increase its foaminess. The solution may be diluted in aqueous medium. The aqueous medium may be distilled water, water, surface water, ground water, brackish water, brine or seawater.

In the present invention, magnesium chloride is added to the mixture as a foam stabilizer. The magnesium chloride displays synergistic activity and compatibility with the components of the foam solution. The magnesium chloride may form a crystal lattice complex which provides high viscosity, thus keeping foams thick and reducing the drainage rate of liquid from foam lamellae. This increase in viscosity may provide the lamellae with “self-healing” or re-generation capabilities—a key feature that eliminates the need for constant re-injection of surfactant(s) which may allow for a minimal surfactant concentration during application. Advantageously, magnesium chloride is certified as GRAS (Generally recognized as safe) by FDA (Food and Drug Administration) whereby chemicals under this category are considered to be non-toxic to human and environment and safe for use in food ingredient and pharmaceuticals. Magnesium chloride is also advantageously cheap to obtain as it is not a proprietary chemical. Further, magnesium chloride is safe and easy to transport, mix and handle compared to using polymers as a foam stabilizer. In addition, magnesium chloride is highly soluble in water. Magnesium chloride is also advantageously a PLONOR (=Pose Little or No Risk)-listed compound by the OSPAR Commission whereby chemicals under this category are considered to be readily biodegradable and non-toxic.

The aqueous medium need not be potable and may be brackish and contain salts of such metals as sodium, potassium, calcium, zinc, magnesium, or other materials typical of sources of water found in or near oil fields. If so, the amount of magnesium chloride added to the mixture may be adjusted such that the total final concentration of magnesium chloride in the composition is about 0.5 wt % to about 1.5 wt %.

The composition for enhanced oil recovery may comprise a mixture comprising an aqueous medium and a mixture comprising sulfo-betaine of Formula (II) or Formula (IIA), betaine of Formula (III) or Formula (IIIA), olefin sulfonate of Formula (I); and about 0.5 wt % to about 1.5 wt % magnesium chloride. The disclosed composition for enhanced oil recovery may comprise a solution comprising an aqueous medium and a mixture comprising about 10.5 wt % to about 12.5 wt % sulfo-betaine of Formula (II) or Formula (IIA), about 11.5 wt % to about 12.5 wt % betaine of Formula (III) or Formula (IIIA), and about 18.0 wt % to about 20.50 wt % olefin sulfonate of Formula (III) or Formula (IIIA), wherein said mixture is diluted in the aqueous medium to about 0.3 w/w % to about 0.5 w/w %; and about 0.5 wt % to about 1.5 wt % magnesium chloride. The disclosed composition for enhanced oil recovery may comprise a solution comprising an aqueous medium and a mixture comprising about 11.0 wt % sulfo-betaine of Formula (II) or Formula (IIA), about 11.75 wt % betaine of Formula (III) or Formula (IIIA), and about 20.00 wt % olefin sulfonate of Formula (III) or Formula (IIIA), wherein said mixture is diluted in the aqueous medium to about 0.3 w/w % to about 0.5 w/w %; and about 0.5 wt % to about 1.5 wt % magnesium chloride.

The composition with foaming properties may comprise cocaamido propyl hydroxy sulfo-betaine, cocaamido propyl betaine, C₁₄-C₁₆ alpha olefin sulfonate; and about 0.5 wt % to about 1.5 wt % magnesium chloride. The disclosed composition for enhanced oil recovery may comprise a solution comprising an aqueous medium and a mixture comprising about 10.5 wt % to about 12.5 wt % cocaamido propyl hydroxy sulfo-betaine, about 11.5 wt % to about 12.5 wt % cocaamido propyl betaine, and about 18.0 wt % to about 20.50 wt % C₁₄-C₁₆ alpha olefin sulfonate, wherein said mixture is diluted in the aqueous medium to about 0.3 w/w % to about 0.5 w/w %; and about 0.5 wt % to about 1.5 wt % magnesium chloride. The disclosed composition for enhanced oil recovery may comprise a solution comprising about 11.0 wt % cocaamido propyl hydroxy sulfo-betaine, about 11.75 wt % cocaamido propyl betaine, and about 20.0 wt % C₁₄-C₁₆ alpha olefin sulfonate, wherein said solution is diluted in aqueous medium to about 0.3 w/w % to about 0.5 w/w %; and about 0.5 wt % to about 1.5 wt % magnesium chloride.

The composition for enhanced oil recovery may comprise sulfo-betaine selected from the group consisting of the following compounds:

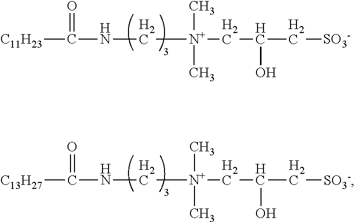

betaine selected from the group consisting of the following compounds:

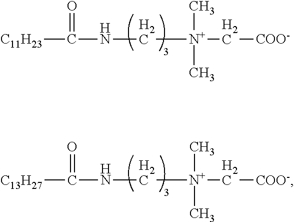

olefin sulfonate selected from the group consisting of the following compounds:

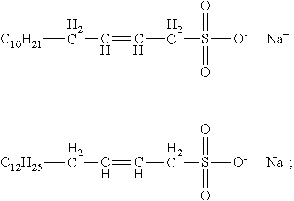

and about 0.5 wt % to about 1.5 wt % magnesium chloride.

The composition for enhanced oil recovery may comprise an aqueous medium and a mixture comprising about 10.5 wt % to about 12.5 wt % sulfo-betaine selected from the group consisting of the following compounds:

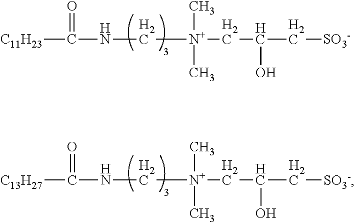

about 11.5 wt % to about 12.5 wt % betaine selected from the group consisting of the following compounds:

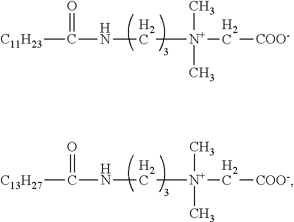

about 18.0 wt % to about 20.50 wt % olefin sulfonate selected from the group consisting of the following compounds:

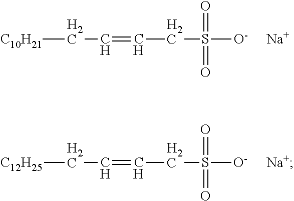

wherein said mixture is diluted in the aqueous medium to about 0.3 w/w % to about 0.5 w/w %; and about 0.5 wt % to about 1.5 wt % magnesium chloride.

The composition for enhanced oil recovery may comprise a solution comprising an aqueous medium and a mixture comprising about 11.0 wt % sulfo-betaine selected from the group consisting of the following compounds:

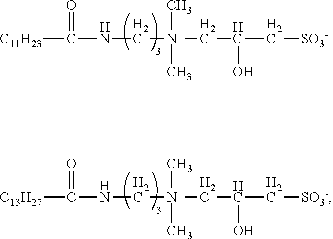

about 11.75 wt % betaine selected from the group consisting of the following compounds:

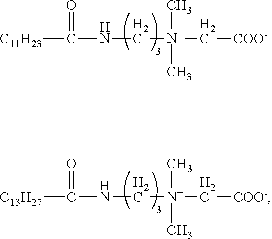

about 20.0 wt % olefin sulfonate selected from the group consisting of the following compounds:

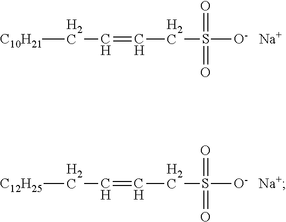

wherein said solution is diluted in aqueous medium to about 0.3 w/w % to about 0.5 w/w %; and about 0.5 wt % to about 1.5 wt % magnesium chloride.

The composition may be useful to generate stable foams at high temperature and salinity.

The composition may be useful to generate stable foams at a temperature of about 96° C. to about 106° C., about 96° C. to about 105° C., about 96° C. to about 104° C., about 96° C. to about 103° C., about 96° C. to about 102° C., about 96° C. to about 101° C., about 96° C. to about 100° C., about 96° C. to about 99° C., about 96° C. to about 98° C., about 96° C. to about 97° C., about 97° C. to about 106° C., about 98° C. to about 106° C., about 99° C. to about 106° C., about 100° C. to about 106° C., about 101° C. to about 106° C., about 102° C. to about 106° C., about 103° C. to about 106° C., about 104° C. to about 106° C., about 105° C. to about 106° C., about 96° C., about 97° C., about 98° C., about 99° C., about 100° C., about 101° C., about 102° C., about 103° C., about 104° C., about 105° C., or about 106° C. It is to be appreciated that the above ranges should be interpreted as including and supporting any sub-ranges or discrete values (which may or may not be a whole number) that are within the stated range(s).

The composition may be useful to generate stable foams at salinity of more than about 35,000 ppm, more than about 40,000 ppm, more than about 45,000 ppm, more than about 50,000 ppm, more than about 60,000 ppm, more than about 70,000 ppm, more than about 80,000 ppm, more than about 90,000 ppm, up to about 100,000 ppm, or any range or integer falling within about 30,000 to about 100,000 ppm.

The composition may be able to generate stable thick foam lamellae. The viscosity of the foam generated at 25° C. may be of about 30 to about 100 cP (or mPa·s), about 35 to about 100 cP (or mPa·s), about 40 to about 100 cP (or mPa·s), about 45 to about 100 cP (or mPa·s), about 50 to about 100 cP (or mPa·s), about 55 to about 100 cP (or mPa·s), about 60 to about 100 cP (or mPa·s), about 65 to about 100 cP (or mPa·s), about 70 to about 100 cP (or mPa·s), about 75 to about 100 cP (or mPa·s), about 80 to about 100 cP (or mPa·s), about 85 to about 100 cP (or mPa·s), about 90 to about 100 cP (or mPa·s), about 95 to about 100 cP (or mPa·s), about 30 to about 95 cP (or mPa·s), about 30 to about 90 cP (or mPa·s), about 30 to about 85 cP (or mPa·s), about 30 to about 80 cP (or mPa·s), about 30 to about 75 cP (or mPa·s), about 30 to about 70 cP (or mPa·s), about 30 to about 65 cP (or mPa·s), about 30 to about 60 cP (or mPa·s), about 30 to about 55 cP (or mPa·s), about 30 to about 50 cP (or mPa·s), about 30 to about 45 cP (or mPa·s), about 30 to about 40 cP (or mPa·s), about 30 to about 35 cP (or mPa·s), about 30 cP (or mPa·s), about 35 cP (or mPa·s), about 40 cP (or mPa·s), about 45 cP (or mPa·s), about 50 cP (or mPa·s), about 55 cP (or mPa·s), about 60 cP (or mPa·s), about 65 cP (or mPa·s), about 70 cP (or mPa·s), about 75 cP (or mPa·s), about 80 cP (or mPa·s), about 85 cP (or mPa·s), about 90 cP (or mPa·s), about 95 cP (or mPa·s), or about 100 cP (or mPa·s). It is to be appreciated that the above ranges should be interpreted as including and supporting any sub-ranges or discrete values (which may or may not be a whole number) that are within the stated range(s).

The composition may be able to generate stable foams at oil saturation of about 10 to about 20% (volume/volume), about 12 to about 20% (volume/volume), about 14 to about 20% (volume/volume), about 16 to about 20% (volume/volume), about 18 to about 20% (volume/volume), about 10 to about 18% (volume/volume), about 10 to about 16% (volume/volume), about 10 to about 14% (volume/volume), about 10 to about 12% (volume/volume), about 10% (volume/volume), about 12% (volume/volume), about 14% (volume/volume), about 16% (volume/volume), about 18% (volume/volume), or about 20% (volume/volume). It is to be appreciated that the above ranges should be interpreted as including and supporting any sub-ranges or discrete values (which may or may not be a whole number) that are within the stated range(s).

The composition may be used as a foam.

The composition may comprise an aqueous medium. The composition may comprise an aqueous medium and a foaming gas. The aqueous medium may be distilled water, double distilled water, brine, sea water, brackish water, or surface water. The foaming gas may be any gas that imparts foaming properties to the composition such as nitrogen, oxygen, carbon dioxide, natural gas, methane, propane, butane, and mixtures thereof. The foaming gas may generate a stable foam with said composition upon contact. The stability of the generated foam may be sustained after multiple contacts with a foaming gas.

The composition when used as a foam, may have a foam half-life between about 195 to about 525 seconds, about 205 to about 525 seconds, about 215 to about 525 seconds, about 225 to about 525 seconds, about 235 to about 525 seconds, about 245 to about 525 seconds, about 255 to about 525 seconds, about 265 to about 525 seconds, about 275 to about 525 seconds, about 285 to about 525 seconds, about 295 to about 525 seconds, about 305 to about 525 seconds, about 315 to about 525 seconds, about 325 to about 525 seconds, about 335 to about 525 seconds, about 345 to about 525 seconds, about 355 to about 525 seconds, about 365 to about 525 seconds, about 375 to about 525 seconds, about 385 to about 525 seconds, about 395 to about 525 seconds, about 405 to about 525 seconds, about 415 to about 525 seconds, about 425 to about 525 seconds, about 435 to about 525 seconds, about 445 to about 525 seconds, about 455 to about 525 seconds, about 465 to about 525 seconds, about 475 to about 525 seconds, about 485 to about 525 seconds, about 495 to about 525 seconds, about 505 to about 525 seconds, about 515 to about 525 seconds, about 195 to about 515 seconds, about 195 to about 505 seconds, about 195 to about 495 seconds, about 195 to about 485 seconds, about 195 to about 475 seconds, about 195 to about 465 seconds, about 195 to about 455 seconds, about 195 to about 445 seconds, about 195 to about 435 seconds, about 195 to about 425 seconds, about 195 to about 415 seconds, about 195 to about 405 seconds, about 195 to about 395 seconds, about 195 to about 390 seconds, about 195 to about 380 seconds, about 195 to about 370 seconds, about 195 to about 360 seconds, about 195 to about 350 seconds, about 195 to about 340 seconds, about 195 to about 330 seconds, about 195 to about 320 seconds, about 195 to about 310 seconds, about 195 to about 300 seconds, about 195 to about 290 seconds, about 195 to about 280 seconds, about 195 to about 270 seconds, about 195 to about 260 seconds, about 195 to about 250 seconds, about 195 to about 240 seconds, about 195 to about 230 seconds, about 195 to about 220 seconds, about 195 to about 210 seconds, about 195 to about 200 seconds, about 195 seconds, about 200 seconds, about 205 seconds, about 210 seconds, about 215 seconds, about 220 seconds, about 225 seconds, about 230 seconds, about 235 seconds, about 240 seconds, about 245 seconds, about 250 seconds, about 255 seconds, about 260 seconds, about 265 seconds, about 270 seconds, about 275 seconds, about 280 seconds, about 285 seconds, about 290 seconds, about 295 seconds, about 300 seconds, about 305 seconds, about 310 seconds, about 315 seconds, about 320 seconds, about 325 seconds, about 330 seconds, about 335 seconds, about 340 seconds, about 345 seconds, about 350 seconds, about 355 seconds, about 360 seconds, about 365 seconds, about 370 seconds, about 375 seconds, about 380 seconds, about 385 seconds, about 390 seconds, about 395 seconds, about 400 seconds, about 405 seconds, about 410 seconds, about 415 seconds, about 420 seconds, about 425 seconds, about 430 seconds, about 435 seconds, about 440 seconds, about 445 seconds, about 450 seconds, about 455 seconds, about 460 seconds, about 465 seconds, about 470 seconds, about 475 seconds, about 480 seconds, about 485 seconds, about 490 seconds, about 495 seconds, about 500 seconds, about 505 seconds, about 510 seconds, about 515 seconds, about 520 seconds, or about 525 seconds, t is to be appreciated that the above ranges should be interpreted as including and supporting any sub-ranges or discrete values (which may or may not be a whole number) that are within the stated range(s).

The composition when used as a foam, may have gas mobility reduction factor (MRF) above about 10, above about 11, above about 12, above about 13, above about 14, or above about 15. It is to be appreciated that the above ranges should be interpreted as including and supporting any sub-ranges or discrete values (which may or may not be a whole number) that are within the stated range(s).

The composition when used as a foam, may be biodegradable. The biodegradability of composition may be more than about 60% in ThOD (theoretical oxygen demand), more than about 65% in TOD, more than about 70% in TOD, more than about 75% in ThOD, more than about 80% in TOD, more than about 85% in ThOD, more than about 90% in TOD, or more than about 95% in TOD. It is to be appreciated that the above ranges should be interpreted as including and supporting any sub-ranges or discrete values (which may or may not be a whole number) that are within the stated range(s).

The composition when used as a foam, may have low bioaccumulation tendency. The partition coefficient (Log P_{ow}) of the composition may be less than about 3, less than 2.5, less than 2, less than 1.5, less than 1, or less than 0.5. It is to be appreciated that the above ranges should be interpreted as including and supporting any sub-ranges or discrete values (which may or may not be a whole number) that are within the stated range(s).

The BCF (bioconcentration factor) of the composition may be less than about 100, less than about 90, less than about 80, less than about 70, less than about 60, less than about 50, less than about 40, less than about 30, less than about 20, less than about 10, or less than about 1. It is to be appreciated that the above ranges should be interpreted as including and supporting any sub-ranges or discrete values (which may or may not be a whole number) that are within the stated range(s).

In another aspect, the present disclosure refers to a composition disclosed herein, when used in offshore direct discharge after use.

In yet another aspect, the present disclosure refers to a composition disclosed herein, when used as a foam.

In a further aspect, the present disclosure refers to a composition disclosed herein, when used in oil recovery processes.

According to a further aspect, the present disclosure refers to a process for preparing a composition disclosed herein, comprising:
(a) preparing a solution comprising about 18.0 wt % to about 20.50 wt % olefin sulfonate, 10.5 wt % to about 12.5 wt % sulfo-betaine, and about 11.5 wt % to about 12.5 wt % betaine;
(b) preparing a mixture by diluting the solution of step (a) with aqueous medium to a concentration of about 0.3 w/w % to about 0.5 w/w %; and
(c) adding magnesium chloride to the diluted mixture of step (b) to obtain a composition comprising a final concentration of about 0.5 wt % to about 1.5 wt % magnesium chloride.

In another aspect, the present disclosure refers to a method to enhance the recovery of oil from a subterranean oil-containing formation comprising the use of a composition disclosed herein, comprising:
(a) introducing a composition disclosed herein into the subterranean oil-containing formation;
(b) introducing a gas into the subterranean oil-containing formation, wherein the presence of the composition with foaming properties lowers the gas mobility within said formation; and
(c) recovering oil from the formation.

In yet another aspect, the present disclosure refers to a method to enhance the recovery of oil from a subterranean oil-containing formation comprising the use of a composition disclosed herein, comprising:
(a) injecting a composition disclosed herein into the subterranean oil-containing formation through one or more injection wells;
(b) introducing a gas into the subterranean oil-containing formation, wherein the presence of the composition with foaming properties lowers the gas mobility within said formation;
(c) extracting oil from the formation through one or more production wells.

The composition disclosed herein may be part of a package introduced into a subterranean oil-containing formation by itself or with another fluid.

The composition disclosed herein may be used as a fire fighting foam, foam cleaner, industrial foam, agricultural foam or foam used in home and personal care products.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 shows a schematic representation of the mechanism of magnesium chloride in improving foam stability in foam composition of present invention (Example 2).

FIG. 2 shows a foam half-life comparison study of foam composition of present invention (Example 2) with two other comparative foam compositions in Oil Field A (96° C.), Oil Field B (98° C.) and Oil Field C (106° C.) field, respectively. The dominant gas of Oil Fields A, B and C are CO₂, CH₄ and CH₄, respectively.

### DETAILED DESCRIPTION OF DRAWINGS

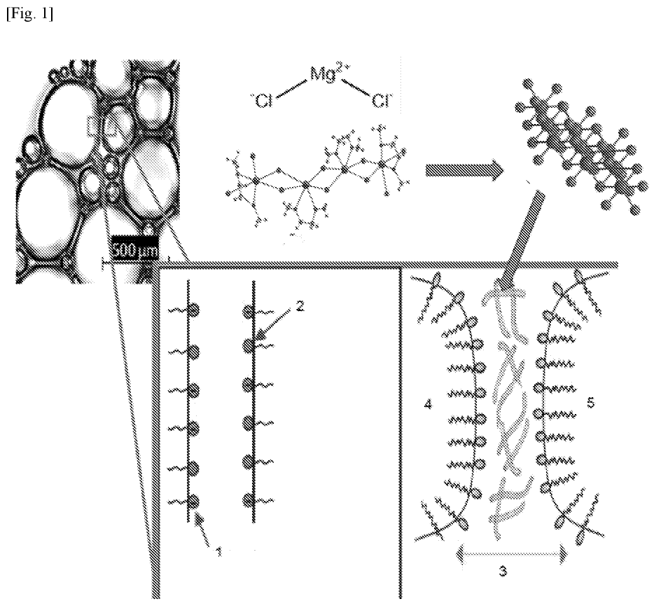

FIG. 1 shows that magnesium chloride salt exhibits synergistic activity and compatibility with ionic surfactant (1) and amphoteric surfactants (2). As magnesium chloride lattice complex bridges thick foam lamellae (3) at the gas interface (4), the foam composition of the present invention advantageously provides a viscosity similar to polymer. This bridging effect reduces the drainage rate of liquid from foam lamellae and allows high foam stability to be achieved.

### EXAMPLES

Non-limiting examples of the invention and a comparative example will be further described in greater detail by reference to specific Examples, which should not be construed as in any way limiting the scope of the invention.

### Materials

Witconate AOS obtained from AkzoNobel N.V.
Betadet SHR obtained from Kao Chemicals Europe S.L.
Betadet HR-50K obtained from Kao Chemicals Europe S.L.

### Example 1: Preparation of Composition

A surfactant composition was prepared as follow. 75 g of Witconate AOS was weighed into a 500 mL beaker. Within the same beaker, 37.50 g of Betadet SHR and 37.50 g of Betadet HR-50K were weighed. By using a laboratory stand mixer, the three chemicals were mixed together at 400 rpm until the mixture was observed to be homogenous. The mixture was then left to stand overnight or until the bubbles have disappeared. The concentration of active components in the surfactant mixture is shown in Table 1.

TABLE 1

| | (Specific) Active concen- | |
|---|---|---|
| | tration in the mixture | % of each component |
| Components | (wt %) | in the mixture |
| Witconate AOS | 20.00 | 50.0 |
| (Alpha olefin | | |
| sulfonate C14-C16) | | |
| Betadet SHR | 11.00 | 25.0 |
| (sulfo-betaine) | | |
| Betadet HR-50K | 11.75 | 25.0 |
| (betaine) | | |
| TOTAL | 42.75% | 100% |

Subsequently, the mixture was diluted by weighing 1.39 g of the solution and topping up with 200 g of brine from an oil field (Oil Field C). The surfactant mixture was stirred until fully dissolved, making 0.3 w/w % of surfactant mixture.

The brine from Oil Field C contains salts of such metals as sodium, potassium, calcium, magnesium, and barium which is typical of sources of water found in or near oil fields. The amount of magnesium chloride added to the mixture may be adjusted such that the total final concentration of magnesium chloride in the composition is about 0.5 wt % to about 1.5 wt %. The properties of the brine from Oil Field C are shown in Table 2.

TABLE 2
Brine Properties of Oil Field C

| Ions | Concentration (mg/L) |
|---|---|
| Na⁺ | 9,776 |
| K⁺ | 352 |
| Ca²⁺ | 295 |
| Mg²⁺ | 1,265 |
| Ba²⁺ | 0.049 |
| Cl⁻ | 17,371 |
| HCO₃⁻ | 133 |
| SO₄²⁻ | 1,900 |

The MgCl₂ concentration calculated from the brine of Oil Field C was 4.956 g/L (i.e. about 0.9912 g in 200 g Oil Field C brine). 0.1904 g of magnesium chloride (MgCl₂) salt (powder) was dispensed into the 0.3 w/w % solution using a spatula, to make a total MgCl₂ concentration of 0.59 wt %. The powder mixture was mixed until fully dissolved.

### Example 2: Foam Stability Test of Composition

Foam stability test was conducted using FoamScan Teclis Instrument (Teclis, France). Foam stability was investigated using foam half-life of its initial volume created in the foam column. 80 mL of the prepared foam composition of Example 2 was injected into the foam column. The foam stability test parameters are summarized in Table 3. The temperature of the test was set to 96-106° C. and the pressure was fixed at 1 bar. The test was carried out in two conditions—with crude oil and without crude oil. In the with crude oil condition, 10 v/v % of 80 mL of crude oil was injected together with the foam composition.

The foam stability test parameters are shown in Table 3. The foam stability half life test results are shown in Table 6.

TABLE 3
Foam stability test parameters

| Foam stability test | | |
|---|---|---|
| parameters | Values | |
| Temperature: | | |
| Oil Field A | 96° | C. |
| Oil Field B | 98° | C. |
| Oil Field C | 106° | C. |
| Gas flow rate | 100 | mL/min |
| Pressure | 1 | bar |
| Oil saturation | 10 | v/v % |

The properties of the brine from Oil Fields A and B are shown in Tables 4 and 5.

TABLE 4
Brine Properties of Oil Field A

| Ions | Concentration (mg/L) |
|---|---|
| Na⁺ | 10,070 |
| K⁺ | 393 |
| Ca²⁺ | 382 |
| Mg²⁺ | 1,172 |
| Ba²⁺ | 0 |
| Cl⁻ | 19,455 |
| HCO₃⁻ | 133 |
| SO₄²⁻ | 2,040 |

The MgCl₂ concentration calculated from the brine of Oil Field A was 4.59 g/L (i.e. about 0.918 g in 200 g Oil Field A brine). A foam composition using Oil Field A brine was prepared in a similar manner according to Example 1. 0.1904 g of magnesium chloride (MgCl₂) salt (powder) was dispensed into the 0.3 w/w % solution using a spatula, to make a total MgCl₂ concentration of 0.55 wt %. The powder mixture was mixed until fully dissolved.

TABLE 5
Brine Properties of Oil Field B

| Ions | Concentration (mg/L) |
|---|---|
| Na⁺ | 9,376 |
| K⁺ | 325 |
| Ca²⁺ | 289 |
| Mg²⁺ | 1,189 |
| Ba²⁺ | 0 |
| Cl⁻ | 16,328 |
| HCO₃⁻ | 183 |
| SO₄²⁻ | 2,500 |

The MgCl₂ concentration calculated from the brine of Oil Field B was 4.65 g/L (i.e. about 0.93 g in 200 g Oil Field B brine). A foam composition using Oil Field A brine was prepared in a similar manner according to Example 1. 0.1904 g of magnesium chloride (MgCl₂) salt (powder) was dispensed into the 0.3 w/w % solution using a spatula, to make a total MgCl₂ concentration of 0.56 wt %. The powder mixture was mixed until fully dissolved.

TABLE 6

| | Foam Half life without | Half-life with |
|---|---|---|
| Formulation | crude oil | Crude oil |
| Foam composition using Oil | 324 | 343 |
| Field A brine (methane) | | |
| Foam composition using Oil | 267 | 203 |
| Field B brine (CO₂) | | |
| Foam composition using Oil | 500 | 411 |
| Field C brine (nitrogen) | | |

### Example 3: Gas Mobility Reduction Factor (MRF) Test

Gas Mobility Reduction Factor (MRF) is defined as a ratio of the measured sectional pressure drop for foam flow to the corresponding pressure drop for the flow of methane gas at the same superficial velocity. A high differential pressure and MRF will indicate the presence of strong foam inside the core. A sustained MRF and differential pressure trend can be attributed to the stability of the foam. MRF is defined in the equation below:

$$M R F = \frac{Δ P Foam}{Δ P No Foam}$$

### Where:

ΔP foam=pressure drop of foam injection at same velocity as gas (psi)
ΔP no-foam=pressure drop of gas injection at same velocity as foam (psi) MRF was measured from coreflood experiments, the ΔP foam and ΔP no-foam are measured as the differential pressure across the core, with and without foam, respectively. In a surfactant-alternating-gas (SAG) approach, firstly, the differential pressures are recorded for gas (only) at flow rate of 0.1, 0.2, 0.4 and 0.6 mL/min. When foam composition is injected through the core, the differential pressures are then recorded at gas injection flow rate is of 0.1, 0.2, 0.4 and 0.6 mL/min. The MRF is then calculated as per equation above for the same flow rates.
The MRF test parameters are shown in Table 7 and the results are shown in Table 8.

TABLE 7

| Coreflood conditions (Oil Field C) | Value | |
|---|---|---|
| Temperature | 106° | C. |
| Pressure | 2000 | psi |
| Type of gas | Methane (pure) | |
| Core dimension (length × diameter) | 7.0 cm × 3.7 cm | |
| Permeability of core (Kw) | 50-300 | mD |

TABLE 8
Average MRF

| | | Rate | Present invention |
|---|---|---|---|
| Injection | Stage | (cc/min) | (Example 2) |
| Surfactant | SAG1 | 0.1 | 1 |
| Gas | | 0.1 | 1 |
| Surfactant | SAG2 | 0.1 | 8 |
| Gas | | 0.1 | 2 |
| Surfactant | SAG3 | 0.2 | 12 |
| Gas | | 0.2 | 4 |
| Surfactant | SAG4 | 0.4 | 16 |
| Gas | | 0.4 | 4 |
| Surfactant | SAG5 | 0.6 | 16 |
| Gas | | 0.6 | 7 |

### Example 4: Chemical Hazard Assessment and Risk Management (CHARM) Dilution Modelling of Composition

CHARM dilution modelling under the OSPAR Convention was conducted to determine the risk and extent of chemical movement in the ocean. This is a vital decision-making tool to determine if the chemicals are safe to be discharged overboard. To be determined safe to discharge overboard, the chemicals should at least rank GOLD or SILVER band, indicating a low hazard quotient (HQ).

Extensive ecotoxicology evaluations on the degree of toxicity, biodegradability and persistency of a foam composition of the present invention were performed using recognised standard methods for eco-toxicity evaluation from the Organisation for Economic Co-operation and Development (OECD). A composition of the present invention has the following eco-toxicological values:

Persistency (Bioaccumulation) for each component:
All components of a composition of the present invention are non-persistent. All components meet the persistency criteria of either: Log Pow >3 or BCF<100, MW >300)

### Biodegradability of Formulation:

A composition of the present invention is readily biodegradable=89.05% degradation after 28 days.
Toxicity of organisms from three trophic levels:
Acute toxicity on fish, LC₅₀=2.55 mg/L
Acute toxicity on invertebrate (Daphnia magna), EC₅₀=9.4 mg/L
Acute toxicity on algae, EC₅₀=7.79 mg/L

Based on the above, the composition of the present invention has met the Applicability check (Persistency and Biodegradation criteria) set by OSPAR. The next step was to evaluate/calculate the extent of toxicity over time through a risk assessment known as the hazard quotient (HQ) using the CHARM dilution model.

The PNEC (predicted no effect concentration) is derived on the basis of the results obtained in the ecotoxicology studies with algae, invertebrate and fish, by dividing the lowest observed effect concentration by an appropriate assessment factor which is found in the ECHA Guidance Document R.10. Here, the lowest toxicity value is LC₅₀=2.55 mg/L from acute toxicity to fish. According to the ECHA Guidance R.10, an assessment of 10,000 for the derivation of PNEC should be applied, i.e.:

$$PNEC ( ug / L ) = \frac{Lowest Toxicity Value ( ug / L )}{Assessment Factor}$$

$$\begin{matrix}= 2.55 mg / L / 10 , 000 \\ = 0.000255 mg / L \\ = 0.255 μg / L\end{matrix}$$

Then, the PEC (predicted environmental concentration) for the on-going discharge is calculated using the following equation:

$$P E {C}_{w a t er , on - going} = \frac{\frac{{f}_{r} \cdot {F}_{squeezing treatment} \cdot {C}_{squeezing treatment}}{Δ t}}{{F}_{p w}} \cdot {D}_{distance , x}$$

In which:
fr=fraction released (=0.33)
C_{squeezing treatment}=initial concentration of chemical in the chemical solution
F_{squeezing treatment}=the total amount in mg/L of chemical solution pumped into the well in the squeezing treatment
Δt is the duration in days of the on-going release. This was set to 90 days
F_{Pw} is the volume of produced water discharged per day (m³/d). A value of 14,964 m³/d is the CHARM default value.
D_{distance,x} is the dilution factor at distance x from the platform. The dilution factor is set to 0.001 at distance of 500 according to CHARM, i.e. D_{distance,_}=0.001.
Calculations of the on-going PECs were carried out by assuming different ratios between F_{squeezing treatment} and F_{pw}.

The Hazard Quotient (HQ) is then calculated by dividing the PEC with the PNEC, or HQ=PEC/PNEC. The HQ results are shown in Table 9 and how HQ values are colour banded is shown in Table 10.

TABLE 9
Hazard Quotient (HQ) and Colour Banding of the composition of Example 2.

| | | | | | | HQ | |
|---|---|---|---|---|---|---|---|
| C_{sq} | | D_{distance, x} | | PEC | PNEC | (=PEC/ | Colour |
| (mg/L) | Fᵣ | (500 m) | F_{sq}/F_{pw} | (mg/L) | (mg/L) | PNEC) | band |
| 3000 | 0.33 | 0.001 | 1/20 | 5.5 × 10⁻⁴ | 0.000255 | 2.16 | Silver |
| | | | | | | | (0 < HQ < 1) |

TABLE 10
Colour banding indicating hazard
rating from CHARM dilution model.

| | | |
|---|---|---|
| Minimum HQ | Maximum HQ | |
| Value | Value | Colour banding |

| | | | |
|---|---|---|---|
| >0 | <1 | Gold | Lowest Hazard |
| ≥1 | <30 | Silver | [symbol] |
| ≥30 | <100 | White | |
| ≥100 | <300 | Blue | |
| ≥300 | <1000 | Orange | Highest Hazard |
| ≥1000 | | Purple | |

The foam composition of Example 2 is considered a Silver ranked chemical if this chemical was to be listed against other chemicals used at North Sea under OSPAR system. A Gold ranked chemical is considered to pose a low hazard to the environment.

As CHARM Model does not model inorganic compounds such as metal salts, magnesium chloride was pre-screened prior to CHARM modelling. During the pre-screening process. Magnesium chloride was evaluated as a single component. Based on the safety data sheet (SDS) of magnesium chloride, LC50 or bioaccumulation values are not applicable and the compound has good biodegradability. Hence, magnesium chloride is considered non-toxic as an individual substance. As a result, having magnesium chloride as part of the foaming composition does not affect the CHARM dilution results presented above.

### COMPARATIVE EXAMPLES

### Comparative Example 1: Foam Stability Comparison

### Preparation of Comparative Foam Composition 1:

75 g of Witconate AOS was weighed into a 500 mL beaker. Within the same beaker, 37.50 g of Betadet SHR, and 37.50 g of Betadet HR-50K were weighed. By using laboratory stand mixer, the three chemicals were mixed together at 400 rpm until the mixture was observed to be homogenous. An acrylic copolymer amphiphilic surfactant solution was prepared by preparing 1.0% of acrylic copolymer amphiphilic surfactant, i.e., 1 mL in 100 mL double distilled water. The solution was stirred and subsequently allowed to stand for 24 hours to form a surfactant blend.

100 mL of acrylic copolymer amphiphilic surfactant solution (that was left to stand for 24 hrs) and 100 mL of the surfactant blend were blended in a ratio of 1:1 using an overhead stirrer at <400 rpm. 200 mL of double distilled water was added during blending until a homogenous solution is obtained. The formulation was left to stand overnight.

### Preparation of Comparative Foam Composition 2:

75 g of Witconate AOS was weighed into a 500 mL beaker. Within the same beaker, 37.50 g of Betadet SHR, and 37.50 g of Betadet HR-50K were weighed. Using a laboratory stand mixer, the three chemicals were mixed together at 400 rpm until the mixture was observed to be homogenous. 66.67 g of Schleroglucan liquid (obtained from Cargill, Incorporated) from its original bottle (supplied as 0.15%) was then weighed into a separate beaker. Under stirring condition, 33.33 g of distilled water was added slowly to dilute Schleroglucan to 0.10%. Thereafter, the diluted Schleroglucan was mixed with the previous surfactant mixture of Witconate AOS, Betadet SHR and Betadet HR-50K to form a homogenous solution.

Subsequently, 150 g of distilled water was added into the above solution and stirred at 200 rpm until homogenous. The solution was then left to stand overnight or until the bubbles have disappeared.

The active concentrations of the two comparative foam compositions are shown in Table 11.

TABLE 11

| | Active concentration in the composition (wt %) | |
|---|---|---|
| | Comparative foam | Comparative foam |
| Components | composition 1 | composition 2 |
| Witconate AOS | 10.00 | 7.50 |
| (Alpha olefin sulfonate | | |
| C14-C16) | | |
| Betadet SHR | 5.5 | 4.13 |
| (sulfo-betaine) | | |
| Betadet HR-50K | 5.88 | 4.41 |
| (betaine) | | |
| Atlox 4913 | 0.44 | 0.00 |
| (Polymeric Amphiphilic | | |
| Surfactant) | | |
| Schleroglucan | 0.00 | 0.04 |
| (Exopolysaccharide) | | |
| TOTAL active | 21.81% | 16.07% |
| concentration | | |

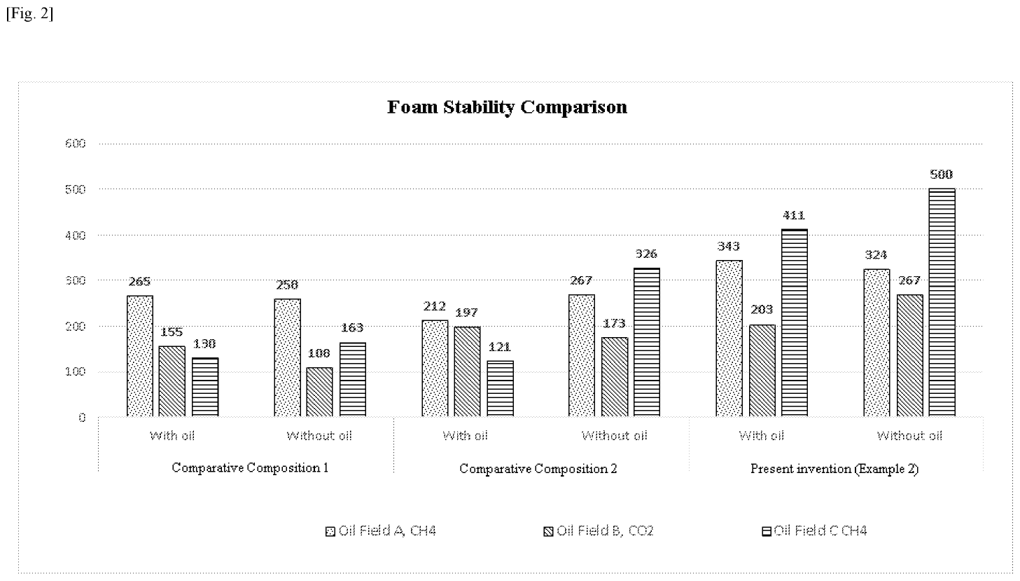

A comparison between the foam composition of the present invention (Example 2) and two other comparative compositions are shown in FIG. 2 and the comparison results are shown in Tables 12 and 13. During the foam stability test, comparative foam compositions 1 and 2 are tested at an active concentration of 0.3 w/w % and the foam composition of present invention (example 2) is tested at an active concentration of 0.3 w/w % with 0.59 wt % M total magnesium chloride concentration.

TABLE 12
Summary of foam half-life (seconds) results
tested in the presence of crude oil.

| | Foam half-life (seconds) | | |
|---|---|---|---|
| With Crude Oil | Oil Field A | Oil Field B | Oil Field C |
| Present invention (Example 2) | 343 | 203 | 196 |
| Comparative composition 1 | 265 | 155 | 130 |
| Comparative composition 2 | 212 | 197 | 121 |

TABLE 13
Summary of foam half-life (seconds) results
tested in the absence of crude oil.

| | Foam half-life (seconds) | | |
|---|---|---|---|
| Without Crude Oil | Oil Field A | Oil Field B | Oil Field C |
| Present invention (Example 2) | 324 | 267 | 500 |
| Comparative composition 1 | 258 | 108 | 163 |
| Comparative composition 2 | 267 | 173 | 326 |

The results shown in Tables 12 and 13 show that foams produced using the foam composition of the present invention are more stable when compared against comparative compositions 1 and 2 which use similar surfactant mixtures, but do not contain MgCl₂.

### Comparative Example 2: Gas Mobility Reduction Factor (MRF) Comparison

The Gas Mobility Reduction Factor (MRF) comparison between the composition of the present invention (Example 2) and comparative compositions 1 and 2 of Comparative Example 1 are shown in Table 14.

TABLE 14
Gas Mobility Reduction Factor (MRF) comparison
between the foam compositions, tested using a Surfactant-
Alternating-Gas (SAG) injection method.
Average MRF Comparison (SAG)

| | | | Average MRF | | |
|---|---|---|---|---|---|
| | | | Present | Comparative | Comparative |
| | | Rate | invention | composition | composition |
| Injection | Stage | (cc/min) | (Example 2) | 1 | 2 |
| Surfactant | SAG1 | 0.1 | 1 | 1 | 1 |
| Gas | | 0.1 | 1 | 1 | 1 |
| Surfactant | SAG2 | 0.1 | 8 | 2 | 6 |
| Gas | | 0.1 | 2 | 2 | 1 |
| Surfactant | SAG3 | 0.2 | 12 | 11 | 11 |
| Gas | | 0.2 | 4 | 1 | 1 |
| Surfactant | SAG4 | 0.4 | 16 | 20 | 13 |
| Gas | | 0.4 | 4 | 3 | 1 |
| Surfactant | SAG5 | 0.6 | 16 | 21 | 15 |
| Gas | | 0.6 | 7 | 7 | 2 |

As shown in Table 14, the average Gas Mobility Reduction Factor (MRF) of a composition of the present invention (Example 2) is comparatively higher than the other two comparative compositions for SAG2 and SAG3. In addition, the average Gas Mobility Reduction Factor (MRF) of a composition of the present invention (Example 2) is comparatively higher than the comparative composition 2 but slightly lowered than comparative composition 1 for SAG4 and SAG5.

Although the MRF of comparative composition 1 is slightly higher than a composition of the present invention for SAG4 and SAG5, it has lower foam stability than the present invention (Example 2) as shown in Comparative Example 1. Additionally, the comparative composition 1 is less environmentally friendly compared to the composition of the present invention (Example 2) as shown in Comparative Example 3 below. Further, the composition of comparative composition 1 is also less cost-effective than the composition of the present invention (Example 2) as shown in Comparative Example 4 below.

### Comparative Example 3: Comparison of Biodegradation, Bioaccumulation and Toxicity Between the Foam Compositions

TABLE 15
Comparison of biodegradation, bioaccumulation
and toxicity between foam compositions.

| | | | Toxicity (CHARM |
|---|---|---|---|
| | Biodegradation | Bioaccumulation | dilution modelling) |
| Present | ✓ | ✓ | ✓(SILVER band) |
| invention | | | |
| (Example 2) | | | |
| Comparative | X | ✓ | ✓(Gold band) |
| composition 1 | | | |
| Comparative | ✓ | ✓ | ✓(Silver band) |
| composition 2 | | | |

As shown in Table 15, the composition of the present invention (Example 2) achieves silver band which is comparable to comparative composition 2 but poorer than comparative composition 1.

Although the composition of comparative composition 1 achieves gold band, the polymeric amphiphilic surfactant component in it has poor biodegradability and is therefore not safe to be discharged overboard as stated in the OSPAR Regulations. Additionally, the composition of comparative composition 1 is also hard to be treated in water treatment and may cause hazards to the environment.

The extent of environmental friendliness depends on all three factors—toxicity, biodegradability, and bioaccumulation. The composition of the present invention in Example 2 only achieves silver band but meets all 3 factors (toxicity, biodegradability and bioaccumulation). Although the composition of comparative composition 1 achieves the gold band, comparative composition 1 has only met 2 factors (bioaccumulation and toxicity). Hence, the composition of the present invention (Example 2) is considered to be more environmentally friendly than the composition of comparative composition 1. Table 16 shows the HQ results of the three compositions.

TABLE 16
Hazard Quotient (HQ) and Colour Banding of the foam composition
of comparative composition 1 and comparative composition 2

| | | | | | | | HQ | |
|---|---|---|---|---|---|---|---|---|
| | C_{sq} | | D_{distance, x} | | PNEC | PEC | (=PEC/ | Colour |
| | (mg/L) | Fᵣ | (500 m) | F_{sq}/F_{pw} | (mg/L) | (mg/L) | PNEC) | band |
| Present | 3000 | 0.33 | 0.001 | 1/20 | 0.000255 | 5.5 × | 2.16 | Silver |
| Invention | | | | | | 10⁻⁴ | | (0 < HQ < 1) |
| (Example 2) | | | | | | | | |
| Comparative | 5000 | 0.33 | 0.001 | 1/20 | 0.0218 | 9.17 × | 0.04 | Gold |
| composition 1 | | | | | | 10⁻⁴ | | (HQ < 1) |
| Comparative | 3000 | 0.33 | 0.001 | 1/20 | 0.000255 | 5.5 × | 2.16 | Silver |
| composition 2 | | | | | | 10⁻⁴ | | (1 < HQ < 30) |

### Comparative Example 4: Cost Comparison

TABLE 17
Cost comparison study with a commercial composition.

| | | | Unit cost of |
|---|---|---|---|
| | | Application | chemical foam |
| | Company/ | concentration | surfactant |
| | Supplier | (%) | (USD/kg) |
| Present invention | Petroliam | 0.3 foam | 3.03 |
| (Example 2) | Nasional | composition + | |
| | Berhad | 0.59 total MgCl2 | |
| | | concentration | |
| Comparative | Petroliam | 0.5 | 3.33 |
| composition 1 | Nasional | | |
| (Comparative | Berhad | | |
| example 1) | | | |
| Comparative | Petroliam | 0.3 | 3.12 |
| composition 2 | Nasional | | |
| (Comparative | Berhad | | |
| example 1) | | | |
| Commercial | DuPont, USA | 0.5 | 4.54 |
| composition | | | |
| (Capstone ® | | | |
| FS-50) | | | |

As shown in Table 17, the composition of the present invention (Example 2) requires a lower application concentration and this translates to an appreciable cost advantage over the comparative composition 1, and a significant cost advantage over Capstone® FS-50.

Although the composition of the present invention (Example 2) requires a higher application concentration as compared to comparative composition 2, the composition of present invention (Example 2) comprises magnesium chloride which is cheaper than components such as exopolysaccharide used in comparative composition 2 Therefore, the foam composition of the present invention (Example 2) still offers a cost advantage over comparative composition 2 despite requiring a slightly higher application concentration.

As the composition of the present invention displays biodegradability and non-toxicity, and is thus safe to be discharged overboard after use, it eliminates the use of end-of-pipe solution and facilities and translates to substantial cost savings. Furthermore, as the composition of the present invention requires a lower application concentration, cheaper components in its composition and lower concentration of each component, it translates to cost-effectiveness and further cost savings.

### Comparative Example 5: Comparison with Different Magnesium Salts

TABLE 18

| | | Foam Half-life (s) at 106° C. using | | |
|---|---|---|---|---|
| | | nitrogen gas (Oil Field C) | | |
| | | Without | With crude oil | Remarks/Observation |
| Example no. | Magnesium salt | crude oil | (from Oil Field C) | (if any) |
| Present | 0.59 wt % total | 500 | 411 | Fully soluble in foam |
| invention | concentration of | | | composition (0.3 |
| (Example 2) | MgCl₂ | | | w/w %) |
| Comparative | 0.45 wt % total | 336 | 333 | Precipitation |
| Composition | concentration of | | | observed |
| 3 | MgO | | | |
| Comparative | 0.54 wt % total | 290 | 383 | Precipitation |
| Composition | concentration of | | | observed |
| 4 | Mg(OH)₂ | | | |

Comparative Compositions 3 and 4 were prepared in a similar manner to Example 1, except that instead of MgCl₂ being added to the surfactant mixture, MgO was added for Comparative Composition 3 and Mg(OH)₂ was added for Comparative Example 4. The total concentration of MgO in Comparative Composition 3 was 0.45 wt %, and the total concentration of Mg(OH)₂ in Comparative Composition 4 was 0.54 wt %.

As shown in Table 18, the selection of magnesium chloride as a foam stabilizer shows better foam stability when compared to the other magnesium salts. This is hypothesized to be because in water, MgCl₂ can form the anion complex MgCl₄²⁻ to form a network of—[MgCl₄]²⁻—[MgCl₄]²⁻—H2O-(bridging between 2 ions and hydrogen bonds with H2O), which is not observed for MgO and Mg(OH)2, primarily because of their insolubility in water. MgCl₂ is fully soluble in brine, while MgO and Mg(OH)₂ are insoluble in brine, resulting in undesirable precipitation).

### Comparative Example 6: Comparison with Different Concentrations of MgCl₂

TABLE 19

| Total | Foam Half-life (s) at 106° C. using | | |
|---|---|---|---|
| concentration | nitrogen gas (Oil Field C) | | Remarks/ |
| of MgCl₂ | Without | With crude oil | Observation |
| wt % | crude oil | (from Oil Field C) | (if any) |
| 0.11 | 116 | 321 | Fully soluble in |
| | | | foam composition |
| | | | (0.3 w/w %) |
| 0.59 | 500 | 411 | Fully soluble in |
| | | | foam composition |
| | | | (0.3 w/w %) |
| 0.97 | 207 | 245 | Slightly turbid |
| 1.44 | 201 | 251 | Turbid |

As shown in Table 19, the optimal concentration for MgCl₂ is 0.5 wt % to 1.5 wt % because foaming compositions containing below 0.5 wt % of magnesium chloride result in a short foam half life, and above 1.5 wt %, turbidity is observed in the foaming composition.

It is hypothesized that the short foam half life observed for foaming compositions containing less than 0.5 wt % of magnesium chloride results as the bridging effect between the crystal lattice complex and surfactants does not occur. In other words, when magnesium chloride is present at a concentration of less than 0.5 wt %, it is unable to bridge between adjacent foam lamellae generated by the surfactant (foam formulation) and does not strengthen the foams any further.

It is also hypothesized that at a concentration higher than 1.5 wt %, too much ions are present at the lamellae, leading to the ‘congestion’ (=turbidity) at the plateau border, competing with surfactants in building lamella, leading to the collapse of the foam.

### INDUSTRIAL APPLICABILITY

The disclosed composition with foaming properties advantageously comprises a divalent metal salt that may be an efficient foam stabilizer, and is readily biodegradable and non-toxic.

Advantageously, the composition with foaming properties may be used to generate a foam that exhibits good foam generation and stability under severe reservoir conditions of high temperatures, high salinity and in the presence of crude oil.

Therefore advantageously, the disclosed composition with foaming properties may be used in improved oil recovery methods and may be directly discharged offshore after use.

There is therefore also provided a method for recovering oil from a subterranean oil-containing formation.

The composition with foaming properties advantageously may be used to generate foam which exhibits a low adsorption rate on reservoir rock and high Mobility Reduction Factor. The lowered gas mobility advantageously results in improved sweep efficiency.

Further advantageously, the composition with foaming properties may be used to generate a stable foam even after repeated contacts with a foaming gas.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A composition for enhanced oil recovery comprising:
olefin sulfonate;
sulfo-betaine;
betaine; and
about 0.5 wt % to about 1.5 wt % magnesium chloride.

2. The composition according to claim 1, wherein the olefin sulfonate is a sodium alpha-olefin sulfonate; or
wherein the olefin sulfonate corresponds in structure to Formula (I): 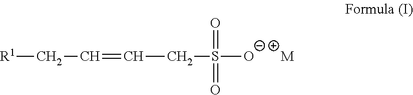
wherein R¹ is an optionally substituted C₁₀ to C₁₂ alkyl, alkenyl or alkynyl; and
M is a counter ion; or
wherein the olefin sulfonate is selected from the group consisting of the following compounds:

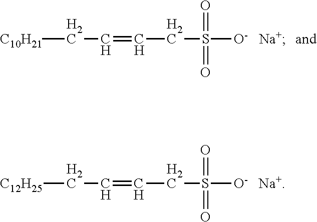

3. (canceled)

4. (canceled)

5. The composition according to claim 1, wherein the sulfo-betaine corresponds in structure to Formula (II): 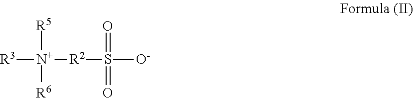
wherein R² is optionally substituted alkylene, alkenylene or alkynylene;
R³ is optionally substituted alkyl, alkenyl or alkynyl; and
R⁵ and R⁶ each are independently optionally substituted alkyl, alkenyl, alkynyl, aryl, heteroaryl, carbocyclyl, or heterocyclyl; or
wherein the sulfo-betaine corresponds in structure to Formula (IIA) 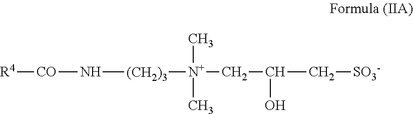
wherein R⁴ is optionally substituted alkyl, alkenyl, alkynyl, or optionally substituted C₁₁ to C₁₃ alkyl; or
wherein the sulfo-betaine is selected from the group consisting of the following compounds:

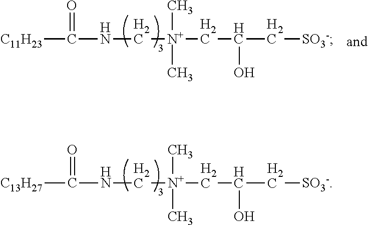

6. (canceled)

7. (canceled)

8. (canceled)

9. The composition according to claim 1, wherein the betaine corresponds in structure to Formula (III): 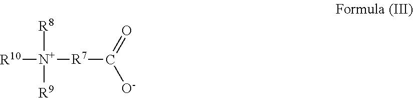
wherein R⁷ is optionally substituted alkylene, alkenylene or alkynylene;
R¹⁰ is optionally substituted alkyl, alkenyl or alkynyl; and
R⁸ and R⁹ each are independently optionally substituted alkyl, alkenyl, alkynyl, aryl, heteroaryl, carbocyclyl, heterocyclyl; or
wherein the betaine corresponds in structure to Formula (IIIA) 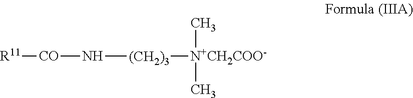
wherein R¹¹ is optionally substituted alkyl, alkenyl, alkynyl, or optionally substituted C₁₁ to C₁₃ alkyl; or
wherein the betaine is selected from the group consisting of the following compounds:

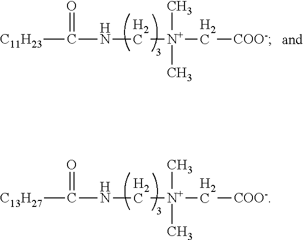

10. (canceled)

11. (canceled)

12. (canceled)

13. The composition according to claim 1, comprising:
an olefin sulfonate corresponding in structure to Formula (I): 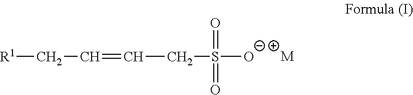
wherein R¹ is an optionally substituted C₁₀ to C₁₂ alkyl, alkenyl or alkynyl; and M is a counter ion;
a sulfo-betaine corresponding in structure to Formula (IIA): 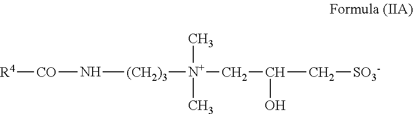
wherein R⁴ is optionally substituted alkyl, alkenyl, or alkynyl;
a betaine of Formula (IIIA): 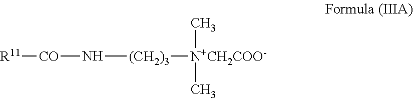
wherein R¹¹ is optionally substituted alkyl, alkenyl, or alkynyl; and
about 0.5 wt % to about 1.5 wt % magnesium chloride.

14. The composition according to claim 1, comprising:
C₁₄ to C₁₆ alpha-olefin sulfonate;
cocaamido propyl hydroxy sulfo-betaine;
cocaamido propyl betaine; and
about 0.5 wt % to about 1.5 wt % magnesium chloride.

15. The composition according to claim 1, comprising:
an olefin sulfonate selected from the group consisting of the following compounds: 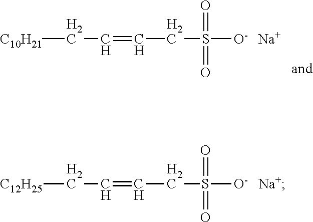
a sulfo-betaine selected from the group consisting of the following compounds: 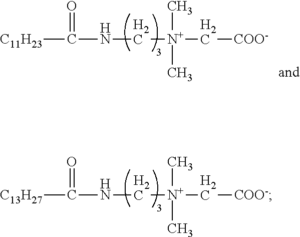
about 0.5 wt % to about 1.5 wt % magnesium chloride.

16. The composition according to claim 1, comprising about 0.5 wt % to about 0.7 wt % magnesium chloride.

17. The composition according to claim 1, further comprising an aqueous medium, preferably wherein the aqueous medium is selected from the group consisting of distilled water, water, ground water, brackish water, surface water, brine and seawater.

18. The composition according to claim 1, wherein said composition comprises:
a solution comprising an aqueous medium and a mixture comprising about 18.0 wt % to about 20.50 wt % olefin sulfonate, about 10.5 wt % to about 12.5 wt % sulfo-betaine, and about 11.5 wt % to about 12.5 wt % betaine, wherein said mixture is diluted in the aqueous medium to about 0.3 w/w % to about 0.5 w/w %; and
about 0.5 wt % to about 1.5 wt % magnesium chloride.

19. (canceled)

20. The composition according to claim 1, wherein said composition does not comprise a polymer.

21. The composition according to claim 1, when used to generate stable foams at high temperature and salinity; of
when used to generate stable foams at a temperature of about 95° C. to about 110° C.; or
when used to generate stable foams at a salinity of more than 35,000 ppm; or
when used to generate stable foam lamellae.

22. (canceled)

23. (canceled)

24. (canceled)

25. The composition with foaming properties according to claim 21, wherein the viscosity of the stable foam generated is between 30 to 100 cP (mPa·s) at 25° C.

26. The composition according to claim 1, further comprising a foaming gas, preferably wherein the foaming gas is selected from the group consisting of nitrogen, oxygen, carbon dioxide, natural gas, methane, propane, butane, and a mixture thereof.

27. (canceled)

28. The composition according to claim 26, wherein the foaming gas generates a stable foam upon contact with said composition.

29. The composition according to claim 28, wherein the stability of the generated foam is sustained after multiple contacts with a foaming gas.

30. The composition according to claim 1, wherein the composition has a foam half-life between 180 to 525 seconds; or
wherein gas mobility reduction factor (MRF) of the composition is in the range of 1 to 16, or
wherein the composition is biodegradable, and wherein the biodegradability of the composition is more than 60% in theoretical oxygen demand (THOD), or
wherein the composition has a low bioaccumulation tendency of partition coefficient (Log P_{ow}) less than 3 and BCF (bioconcentration factor) less than 100.

31. (canceled)

32. (canceled)

33. (canceled)

34. The composition according to claim 1, when used in offshore direct discharge after use; or
when used in an oil recovery process.

35. (canceled)

36. A process for preparing a composition according to claim 1, comprising:
(a) preparing a solution comprising about 18.0 wt % to about 20.50 wt % olefin sulfonate, 10.5 wt % to about 12.5 wt % sulfo-betaine, and about 11.5 wt % to about 12.5 wt % betaine;
(b) preparing a mixture by diluting the solution of step (a) with aqueous medium to a concentration of about 0.3 w/w % to about 0.5 w/w %; and
(c) adding magnesium chloride to the mixture of step (b) to obtain a composition comprising a final concentration of about 0.5 wt % to about 1.5 wt % magnesium chloride.

37. A method for recovering oil from a subterranean oil-containing formation comprising:
(a) introducing a composition with foaming properties according to claim 1 into the subterranean oil-containing formation;
(b) introducing a gas into the subterranean oil-containing formation, wherein the presence of the composition with foaming properties lowers the gas mobility within said formation; and
(c) recovering oil from the formation.

38. (canceled)
